(19) United States
(12) Patent Application Publication
(10) Pub. No.: US 2023/0112036 A1
(43) Pub. Date: Apr. 13, 2023

(54) COMPOSITIONS AND METHODS FOR PARTICLE THREE-DIMENSIONAL PRINTING

(71) Applicant: Holo, Inc., Newark, CA (US)

(72) Inventors: Satyajit BANERJEE, Hercules, CA (US); Hany Basam EITOUNI, Daly City, CA (US)

(73) Assignee: Holo, Inc., Newark, CA (US)

(21) Appl. No.: 17/943,330

(22) Filed: Sep. 13, 2022

Related U.S. Application Data
(63) Continuation of application No. PCT/US2021/022715, filed on Mar. 17, 2021.
(60) Provisional application No. 62/991,165, filed on Mar. 18, 2020.

(51) Int. Cl. B22F 10/00; B33Y 70/10; B29C 64/165; B22F 1/00; B22F 1/10; B22F 1/052; B22F 1/054

(52) U.S. Cl. CPC B22F 10/00; B22F 1/09; B22F 1/10; B22F 1/052; B22F 1/054; B22F 1/056; B29C 64/165; B33Y 70/10; B29K 2505/12

(57) ABSTRACT

The present disclosure provides compositions and methods for printing three-dimensional (3D) objects. A composition for 3D printing may comprise a polymeric precursor configured to form a polymeric material, wherein the polymeric material is configured to decompose at a first temperature. The composition may further comprise a photoinitiator configured to initiate formation of the polymeric material from the polymeric precursor when exposed to photoradiation. The composition may further comprise a plurality of particles comprising a first metal. The composition may further comprise a soluble metallic precursor compound configured to react at a second temperature to form a plurality of nanoparticles comprising a second metal capable of alloying with the first metal.

### CROSS-REFERENCE

This application is a continuation of International Application No. PCT/US2021/022715, filed Mar. 17, 2021, which claims the benefit of U.S. Provisional Pat. Application No. 62/991,165, filed Mar. 18, 2020, each of which is incorporated herein by reference in its entirety.

### BACKGROUND

Photopolymer-based three-dimensional (3D) printers (e.g., bottom-up illumination 3D printing) may project light (i.e., photoradiation) through a window (e.g., an optically transparent or semi-transparent) window and towards a feedstock or resin (e.g., a feedstock disposed on an open platform or in a container) that contains a polymer precursor. As the light is directed to the resin and/or passes through the resin, is the light may be attenuated by absorption, and consequently the greatest photoradiation intensity may be directed at the resin/window interface. In the simplest model of photopolymerization, the polymerization rate may be proportional to photon flux of the photoradiation (e.g., the square root of the photon flux). In some cases, the greatest polymerization rate may occur at the resin/window interface.

When a 3D printing feedstock comprising (i) metal or ceramic suspended particles and (ii) a polymer precursor is hardened with photoradiation, e.g., in stereolithography (SLA) or digital light processing (DLP) 3D printing, the photoradiation can be scattered by the metal or ceramic particles. When the volume fraction of the metal or ceramic particles in the 3D printing feedstock exceeds a threshold (e.g., 35 percent (%)), the penetration depth of the light, which may be limited by such light attenuation, may be typically on the order of the metal or ceramic particle size.

Metal or ceramic green bodies made using 3D printing may be subsequently processed by sintering, during which at least a portion of the metal or ceramic particles may be joined together to eliminate porosity, thereby yielding a finished part (e.g., a monolithic finished part). When the metal or ceramic particles in the green bodies have sizes in the range of about 500 nanometer (nm) to about 10 micrometer (µm), sintering can yield finished parts that have a first density (e.g., a density of about 98% or more). On the other hand, when the metal or ceramic particle have sizes in the range of about 15 µm to about 45 µm, sintering can yield finished parts that have a second density (e.g., a density of about 75% or less) that is lower than the first density, even under the same sintering conditions (e.g., temperature, rate of change of the temperature, time, pressure, etc.). In some cases, even after a longer sintering time, the density of such parts with the lower range of particle sizes may reach about 90% in the sintered product, but achieving further densification of the particles may be difficult.

While smaller metal or ceramic particle sizes may be beneficial for sintering, such particles may hinder a desirable light penetration and/or layer depth. Such particles, e.g., powders having an average diameter of about 500 nm to 10 µm, can yield only thin layers in the printing process because of the relation between the particle size and the penetration depth of the light, as described herein. As a result, more layers may be required to be printed when the printed layers are thin (e.g., via using a resin comprising smaller metal or ceramic particles) than when the layers are relatively thicker (e.g., via using a resin comprising relatively larger metal or ceramic particles). In some cases, having to print more layers may increase the time it takes to print a part. In some cases, it may be difficult to print a 3D object with such very thin layers. In some cases, it may not even be possible to print a part with very thin layers, due to reduce adhesion between a newly printed layer and a previously printed layer.

Thus, there may be a tradeoff. Large particles may be desirable to reach high penetration depth (thicker layers), but large particles may not sinter to desirable high densities. On the other hand, small particles may sinter to high densities, but the layer thickness for printing (e.g., polymerizing and/or crosslinking via photoradiation) may be too thin for printing an object with a desired property (e.g., density or strength) in a reasonable time.

### SUMMARY

In view of the foregoing, recognized herein is a need for alternative compositions and methods of use thereof for three-dimensional (3D) printing, e.g., a feedstock that contains metal and/or ceramic particles or an adjustment of processing conditions thereof to achieve adequately thick printed layers and/or high-density sintering.

The present disclosure provides a feedstock for 3D printing, as well as soluble metal precursor compounds or core-shell particles that can be added to such feedstock to increase the metal and/or ceramic content of the feedstock without increasing light scattering by such metal and/or ceramic material during the 3D printing.

In an aspect, the present disclosure provides a feedstock mixture for three-dimensional (3D) printing, comprising: a polymeric precursor configured to form a polymeric material, wherein the polymeric material is configured to decompose at a first temperature; a first plurality of particles comprising a first metal; and a soluble metallic precursor compound configured to react at a second temperature to form a second plurality of particles comprising a second metal capable of alloying with the first metal.

In some embodiments, the second temperature is less than or equal to the first temperature.

In some embodiments of any one of the feedstock mixture disclosed herein, a weight ratio between the first metal (M1) and the second metal (M2) in the feedstock mixture is greater than 5:5 (M1:M2). In some embodiments of any one of the feedstock mixture disclosed herein, the weight ratio (M1:M2) is greater than or equal to about 6:4. In some embodiments of any one of the feedstock mixture disclosed herein, the weight ratio (M1:M2) is greater than or equal to about 9:1.

In some embodiments of any one of the feedstock mixture disclosed herein, the first metal and the second metal are different.

In some embodiments of any one of the feedstock mixture disclosed herein, the first metal is copper.

In some embodiments of any one of the feedstock mixture disclosed herein, the second metal is silver, and the soluble precursor compound comprises one or more members selected from the group consisting of silver carbonate, silver nitrate, silver acetate, silver citrate hydrate, and silver lactate.

In some embodiments of any one of the feedstock mixture disclosed herein, the second metal is zinc, and the soluble precursor compound comprises one or more members selected from the group consisting of zinc carbonate, zinc nitrate, zinc acetate, zinc citrate hydrate, and zinc lactate.

In some embodiments of any one of the feedstock mixture disclosed herein, the second metal is nickel, and the soluble precursor compound comprises one or more members selected from the group consisting of nickel oxide, nickel sulfate, nickel nitrate, nickel chloride, nickel bromide, nickel fluoride, nickel acetate, nickel acetylacetonate, and nickel hydroxide.

In some embodiments of any one of the feedstock mixture disclosed herein, the first plurality of particles comprising the first metal has an average diameter between about 5 micrometer (µm) and about 60 µm.

In some embodiments of any one of the feedstock mixture disclosed herein, the second plurality of particles are nanoparticles.

In some embodiments of any one of the feedstock mixture disclosed herein, the second plurality of particles comprising the second metal has an average diameter between about 10 nanometer (nm) and about 500 nm.

In some embodiments of any one of the feedstock mixture disclosed herein, a melting temperature of the first metal is higher than a melting temperature of the second metal.

In some embodiments of any one of the feedstock mixture disclosed herein, the feedstock mixture further comprises an inert filler. In some embodiments of any one of the feedstock mixture disclosed herein, the inert filler is configured to decompose at a third temperature that is less than the first temperature. In some embodiments of any one of the feedstock mixture disclosed herein, the inert filler is configured to dissolve in a solvent. In some embodiments of any one of the feedstock mixture disclosed herein, the inert filler comprises one or more members selected from the group consisting of polyethylene waxes, polypropylene, polystyrene, polyalphamethylstyrene, polycarbonate, polyethyleneoxide, polypropyleneoxide, and polymethylmethacrylate.

In some embodiments of any one of the feedstock mixture disclosed herein, the feedstock mixture further comprises a photoinitiator configured to initiate formation of the polymeric material from the polymeric precursor when exposed to photoradiation having a wavelength. In some embodiments of any one of the feedstock mixture disclosed herein, the photoinitiator comprises camphorquinone or a functional variant thereof. In some embodiments of any one of the feedstock mixture disclosed herein, the feedstock mixture further comprises a photoinhibitor configured to inhibit formation of the polymeric material from the polymeric precursor when exposed to photoradiation having an additional wavelength that is different than the wavelength. In some embodiments of any one of the feedstock mixture disclosed herein, the photoinhibitor comprises a hexaarylbiimidazole or a functional variant thereof.

In some embodiments of any one of the feedstock mixture disclosed herein, the polymeric precursor comprises one or more acrylates.

In another aspect, the present disclosure provides a green part for forming a three-dimensional (3D) object, comprising: a polymeric material configured to decompose at a first temperature; a first plurality of particles comprising a first metal; and a soluble precursor compound configured to react to form a second plurality of particles comprising a second metal capable of alloying with the first metal.

In some embodiments of any one of the green part disclosed herein, the second temperature is less than or equal to the first temperature.

In some embodiments of any one of the green part disclosed herein, a weight ratio between the first metal (M1) and the second metal (M2) in the green part is greater than 5:5 (M1:M2). In some embodiments, the weight ratio (M1:M2) is greater than or equal to about 6:4. In some embodiments, the weight ratio (M1 :M2) is greater than or equal to about 9:1.

In some embodiments of any one of the green part disclosed herein, the first metal and the second metal are different.

In some embodiments of any one of the green part disclosed herein, the first metal is copper.

In some embodiments of any one of the green part disclosed herein, the soluble precursor compound comprises one or more members selected from the group consisting of silver carbonate, silver nitrate, silver acetate, silver citrate hydrate, and silver lactate.

In some embodiments of any one of the green part disclosed herein, the soluble precursor compound comprises one or more members selected from the group consisting of zinc carbonate, zinc nitrate, zinc acetate, zinc citrate hydrate, and zinc lactate.

In some embodiments of any one of the green part disclosed herein, the second metal is nickel, and the soluble precursor compound comprises one or more members selected from the group consisting of nickel oxide, nickel sulfate, nickel nitrate, nickel chloride, nickel bromide, nickel fluoride, nickel acetate, nickel acetylacetonate, and nickel hydroxide.

In some embodiments of any one of the green part disclosed herein, the first plurality of particles has an average diameter between about 5 micrometer (µm) and about 60 µm.

In some embodiments of any one of the green part disclosed herein, the second plurality of particles are nanoparticles. In some embodiments, the second plurality of particles has an average diameter between about 10 nanometer (nm) and about 500 nm.

In some embodiments of any one of the green part disclosed herein, a melting temperature of the first metal is higher than a melting temperature of the second metal.

In some embodiments of any one of the green part disclosed herein, the green part further comprises an inert filler. In some embodiments of any one of the green part disclosed herein, the inert filler is configured to decompose at a third temperature that is less than the first temperature. In some embodiments of any one of the green part disclosed herein, the inert filler is configured to dissolve in a solvent. In some embodiments of any one of the green part disclosed herein, the inert filler comprises one or more members selected from the group consisting of polyethylene waxes, polypropylene, polystyrene, polyalphamethylstyrene, polycarbonate, polyethyleneoxide, polypropyleneoxide, and polymethylmethacrylate.

In another aspect, the present disclosure provides a method for printing a three-dimensional (3D) object, comprising: (a) providing a mixture comprising (i) a polymeric precursor configured to form a polymeric material, wherein the polymeric material is configured to decompose at a first temperature, (ii) a first plurality of particles comprising a first metal, and (iii) a soluble metallic precursor compound configured to react at a second temperature to form a second plurality of particles comprising a second metal capable of alloying with the first metal; and (b) exposing the mixture to a stimulus to cause at least a subset of the plurality of polymeric precursor to form the polymeric material that at least partially encapsulates the first plurality of particles and the soluble metallic precursor compound.

In some embodiments, the second temperature is less than or equal to the first temperature.

In some embodiments of any one of the method disclosed herein, a weight ratio between the first metal (M1) and the second metal (M2) in the mixture is greater than 5:5 (M1:M2). In some embodiments, the weight ratio (M1:M2) is greater than or equal to about 6:4. In some embodiments, the weight ratio (M1:M2) is greater than or equal to about 9:1.

In some embodiments of any one of the method disclosed herein, the first metal and the second metal are different.

In some embodiments of any one of the method disclosed herein, the first metal is copper.

In some embodiments of any one of the method disclosed herein, the second metal is silver, and the soluble precursor compound comprises one or more members selected from the group consisting of silver carbonate, silver nitrate, silver acetate, silver citrate hydrate, and silver lactate.

In some embodiments of any one of the method disclosed herein, the second metal is zinc, and the soluble precursor compound comprises one or more members selected from the group consisting of zinc carbonate, zinc nitrate, zinc acetate, zinc citrate hydrate, and zinc lactate.

In some embodiments of any one of the method disclosed herein, the second metal is nickel, and the soluble precursor compound comprises one or more members selected from the group consisting of nickel oxide, nickel sulfate, nickel nitrate, nickel chloride, nickel bromide, nickel fluoride, nickel acetate, nickel acetylacetonate, and nickel hydroxide.

In some embodiments of any one of the method disclosed herein, the first plurality of particles has an average diameter between about 5 micrometer (µm) and about 60 µm.

In some embodiments of any one of the method disclosed herein, the second plurality of particles are nanoparticles. In some embodiments, the second plurality of nanoparticles has an average diameter between about 10 nanometer (nm) and about 500 nm.

In some embodiments of any one of the method disclosed herein, a melting temperature of the first metal is higher than a melting temperature of the second metal.

In some embodiments of any one of the method disclosed herein, the method further comprises, subsequent to (b), subjecting the polymeric material that at least partially encapsulates the plurality of particles and the soluble metallic precursor compound to heat, to (1) decompose at least a portion of the polymeric material and (2) cause the soluble metallic precursor compound to react to form the second plurality of particles, thereby forming a brown body.

In some embodiments, one or more of the second plurality of particles are coupled to a particle of the first plurality of particles.

In some embodiments of any one of the method disclosed herein, the heat is at a third temperature that is higher than or equal to (i) the first temperature and (ii) the second temperature. In some embodiments, the method further comprises comprising subjecting the brown body to heat at a sintering temperature to cause the first metal of the first plurality of particles and the second metal of the second plurality of particles to form an alloy, wherein the sintering temperature is higher than the third temperature, thereby forming at least a portion of a 3D metal object. In some embodiments, the sintering temperature is between about 1000° C. (°C) and about 1080° C.

In some embodiments of any one of the method disclosed herein, the mixture further comprises an inert filler. In some embodiments of any one of the method disclosed herein, the inert filler is configured to decompose at a third temperature that is less than the first temperature. In some embodiments of any one of the method disclosed herein, the inert filler is configured to dissolve in a solvent. In some embodiments of any one of the feedstock method disclosed herein, the inert filler comprises one or more members selected from the group consisting of polyethylene waxes, polypropylene, polystyrene, polyalphamethylstyrene, polycarbonate, polyethyleneoxide, polypropyleneoxide, and polymethylmethacrylate.

In some embodiments of any one of the method herein, the mixture further comprises a photoinitiator configured to initiate formation of the polymeric material from the polymeric precursor when exposed to photoradiation having a wavelength. In some embodiments of any one of the method disclosed herein, the photoinitiator comprises camphorquinone or a functional variant thereof. In some embodiments of any one of the method disclosed herein, the mixture further comprises a photoinhibitor configured to inhibit formation of the polymeric material from the polymeric precursor when exposed to photoradiation having an additional wavelength that is different than the wavelength. In some embodiments of any one of the method disclosed herein, the photoinhibitor comprises a hexaarylbiimidazole or a functional variant thereof.

In some embodiments of any one of the method disclosed herein, the polymeric precursor comprises one or more acrylates.

In another aspect, the present disclosure provides a feedstock mixture for three-dimensional (3D) printing, comprising: a polymeric precursor configured to form a polymeric material; and a plurality of heterogeneous particles, wherein a heterogeneous particle of the plurality comprises (i) a first portion comprising a first metal and (ii) a second portion comprising a second metal, and wherein the first metal of the first portion and the second metal of the second portion are capable of forming an alloy.

In some embodiments, the heterogeneous particle has an average diameter between about 1 micrometer (µm) and about 200 µm.

In some embodiments of any one of the feedstock mixture disclosed herein, the heterogeneous particle has an average diameter between about 2 µm and about 100 µm.

In some embodiments of any one of the feedstock mixture disclosed herein, the heterogeneous particle has an average diameter between about 5 µm and about 60 µm.

In some embodiments of any one of the feedstock mixture disclosed herein, the plurality of heterogeneous particles comprises a plurality of core-shell particles, wherein a core-shell particle of the plurality of core-shell particles comprises (i) a core comprising the first metal and (ii) a shell comprising the second metal, wherein the first metal of at least a portion of the core and the second metal of at least a portion of the shell are capable of forming the alloy. In some embodiments of any one of the feedstock mixture disclosed herein, the shell of the core-shell particle comprises a plurality of additional particles, wherein an additional particle of the plurality of additional particles comprises the second metal. In some embodiments of any one of the feedstock mixture disclosed herein, the shell of the core-shell particle has a thicknesses between about 1 percent (%) and about 50% of an average diameter of the core-shell particle. In some embodiments of any one of the feedstock mixture disclosed herein, the shell of the core-shell particle has a thickness between about 1% and about 20% of an average diameter of the core-shell particle.

In some embodiments of any one of the feedstock mixture disclosed herein, the polymeric material is configured to decompose at a first temperature, and wherein the first metal and the second metal are configured to alloy at a second temperature that is higher than the first temperature.

In some embodiments of any one of the feedstock mixture disclosed herein, the first metal is copper. In some embodiments, the second metal comprises one or more members selected from the group consisting of silver, zinc, and nickel.

In some embodiments of any one of the feedstock mixture disclosed herein, a melting temperature of the first metal is higher than a melting temperature of the second metal.

In some embodiments of any one of the feedstock mixture disclosed herein, the feedstock mixture further comprises an inert filler. In some embodiments of any one of the feedstock mixture disclosed herein, the inert filler is configured to decompose at a third temperature that is less than the first temperature. In some embodiments of any one of the feedstock mixture disclosed herein, the inert filler is configured to dissolve in a solvent. In some embodiments of any one of the feedstock mixture disclosed herein, the inert filler comprises one or more members selected from the group consisting of polyethylene waxes, polypropylene, polystyrene, polyalphamethylstyrene, polycarbonate, polyethyleneoxide, polypropyleneoxide, and polymethylmethacrylate.

In some embodiments of any one of the feedstock mixture disclosed herein, the feedstock mixture further comprises a photoinitiator configured to initiate formation of the polymeric material from the polymeric precursor when exposed to photoradiation having a wavelength. In some embodiments of any one of the feedstock mixture disclosed herein, the photoinitiator comprises camphorquinone or a functional variant thereof. In some embodiments of any one of the feedstock mixture disclosed herein, the feedstock mixture further comprises a photoinhibitor configured to inhibit formation of the polymeric material from the polymeric precursor when exposed to photoradiation having an additional wavelength that is different than the wavelength. In some embodiments of any one of the feedstock mixture disclosed herein, the photoinhibitor comprises a hexaarylbiimidazole or a functional variant thereof.

In some embodiments of any one of the feedstock mixture disclosed herein, the polymeric precursor comprises one or more acrylates.

In another aspect, the present disclosure provides a green part for forming a three-dimensional (3D) object, comprising: a polymeric material; and a plurality of heterogeneous particles, wherein a heterogeneous particle of the plurality comprises (i) a first portion comprising a first metal and (ii) a second portion comprising a second metal, and wherein the first metal of the first portion and the second metal of the second portion are capable of forming an alloy.

In some embodiments, the heterogeneous particle has an average diameter between about 1 micrometer (µm) and about 200 µm.

In some embodiments of any one of the green part disclosed herein, the heterogeneous particle has an average diameter between about 2 µm and about 100 µm.

In some embodiments of any one of the green part disclosed herein, the heterogeneous particle has an average diameter between about 5 µm and about 60 µm.

In some embodiments of any one of the green part disclosed herein, the plurality of heterogeneous particles comprises a plurality of core-shell particles, wherein a core-shell particle of the plurality of core-shell particles comprises (i) a core comprising the first metal and (ii) a shell comprising the second metal, wherein the first metal of at least a portion of the core and the second metal of at least a portion of the shell are capable of forming the alloy. In some embodiments of any one of the green part disclosed herein, the shell of the core-shell particle comprises a plurality of additional particles, wherein an additional particle of the plurality of additional particles comprises the second metal. In some embodiments of any one of the green part disclosed herein, the shell of the core-shell particle has a thicknesses between about 1 percent (%) and about 50% of an average diameter of the core-shell particle. In some embodiments of any one of the green part disclosed herein, the shell of the core-shell particle has a thickness between about 1% and about 20% of an average diameter of the core-shell particle.

In some embodiments of any one of the green part disclosed herein, the polymeric material is configured to decompose at a first temperature, and wherein the first metal and the second metal are configured to alloy at a second temperature that is higher than the first temperature.

In some embodiments of any one of the green part disclosed herein, the first metal is copper. In some embodiments, the second metal comprises one or more members selected from the group consisting of silver, zinc, and nickel.

In some embodiments of any one of the green part disclosed herein, a melting temperature of the first metal is higher than a melting temperature of the second metal.

In some embodiments of any one of the green part disclosed herein, the green part further comprises an inert filler. In some embodiments of any one of the green part disclosed herein, the inert filler is configured to decompose at a third temperature that is less than the first temperature. In some embodiments of any one of the green part disclosed herein, the inert filler is configured to dissolve in a solvent. In some embodiments of any one of the green part disclosed herein, the inert filler comprises one or more members selected from the group consisting of polyethylene waxes, polypropylene, polystyrene, polyalphamethylstyrene, polycarbonate, polyethyleneoxide, polypropyleneoxide, and polymethylmethacrylate.

In another aspect, the present disclosure provides a method for printing a three-dimensional (3D) object, comprising: (a) providing a mixture comprising (1) a polymeric precursor, and (2) a plurality of heterogeneous particles, wherein a heterogeneous particle of the plurality of heterogeneous particles comprises (i) a first portion comprising a first metal and (ii) a second portion comprising a second metal, and wherein the first metal and the second metal are capable of forming an alloy; and (b) exposing the mixture to a stimulus to cause at least a subset of the plurality of polymeric precursor to form a polymeric material that at least partially encapsulates the plurality of heterogeneous particles.

In some embodiments, the heterogeneous particle has an average diameter between about 1 micrometer (µm) and about 200 µm.

In some embodiments of any one of the method disclosed herein, the heterogeneous particle has an average diameter between about 2 µm and about 100 µm.

In some embodiments of any one of the method disclosed herein, the heterogeneous particle has an average diameter between about 5 µm and about 60 µm.

In some embodiments of any one of the method disclosed herein, the plurality of heterogeneous particles comprises a plurality of core-shell particles, wherein a core-shell particle of the plurality of core-shell particles comprises (i) a core comprising the first metal and (ii) a shell comprising the second metal, wherein the first metal of at least a portion of the core and the second metal of at least a portion of the shell are capable of forming the alloy. In some embodiments of any one of the method disclosed herein, the shell of the core-shell particle comprises a plurality of additional particles, wherein an additional particle of the plurality of additional particles comprises the second metal. In some embodiments of any one of the method disclosed herein, the shell of the core-shell particle has a thicknesses between about 1 percent (%) and about 50% of an average diameter of the core-shell particle. In some embodiments of any one of the method disclosed herein, the shell of the core-shell particle has a thickness between about 1% and about 20% of an average diameter of the core-shell particle.

In some embodiments of any one of the method disclosed herein, the first metal is copper. In some embodiments, the second metal comprises one or more members selected from the group consisting of silver, zinc, and nickel.

In some embodiments of any one of the method disclosed herein, a melting temperature of the first metal is higher than a melting temperature of the second metal.

In some embodiments of any one of the method disclosed herein, the method further comprises, subsequent to (b), subjecting the polymeric material that at least partially encapsulates the plurality of heterogeneous particles to heat at a temperature to (1) decompose at least a portion of the polymeric material and (2) cause at least a subset of the second portion of the heterogeneous particle to melt, thereby forming a brown body. In some embodiments, the method further comprises subjecting the brown body to heat at a sintering temperature to cause the first metal and the second metal to form an alloy, wherein the sintering temperature is higher than the temperature, thereby forming at least a portion of a 3D metal object. In some embodiments, the sintering temperature is between about 1000° C. (°C) and about 1080° C.

In some embodiments of any one of the method disclosed herein, the mixture further comprises an inert filler. In some embodiments of any one of the method disclosed herein, the inert filler is configured to decompose at a third temperature that is less than the first temperature. In some embodiments of any one of the method disclosed herein, the inert filler is configured to dissolve in a solvent. In some embodiments of any one of the feedstock method disclosed herein, the inert filler comprises one or more members selected from the group consisting of polyethylene waxes, polypropylene, polystyrene, polyalphamethylstyrene, polycarbonate, polyethyleneoxide, polypropyleneoxide, and polymethylmethacrylate.

In some embodiments of any one of the method herein, the mixture further comprises a photoinitiator configured to initiate formation of the polymeric material from the polymeric precursor when exposed to photoradiation having a wavelength. In some embodiments of any one of the method disclosed herein, the photoinitiator comprises camphorquinone or a functional variant thereof. In some embodiments of any one of the method disclosed herein, the mixture further comprises a photoinhibitor configured to inhibit formation of the polymeric material from the polymeric precursor when exposed to photoradiation having an additional wavelength that is different than the wavelength. In some embodiments of any one of the method disclosed herein, the photoinhibitor comprises a hexaarylbiimidazole or a functional variant thereof.

In some embodiments of any one of the method disclosed herein, the polymeric precursor comprises one or more acrylates.

In another aspect, the present disclosure provides a method for generating a three-dimensional (3D) object, comprising: (a) providing a feedstock adjacent to a build surface, the feedstock comprising (i) a polymeric precursor configured to form a polymeric material, wherein the polymeric material is configured to decompose at a first temperature, (ii) a photoinitiator, (iii) a plurality of particles comprising a first metal, and (iv) a soluble precursor compound configured to react at a second temperature to form a plurality of nanoparticles comprising a second metal capable of alloying with the first metal, wherein the second temperature is less than or equal to the first temperature; (b) exposing the feedstock to photoradiation in a 3D printer to form a green part corresponding to the 3D object, wherein the green part comprises the polymeric material, the particles, and the soluble precursor compound; (c) heating the green part at or above the first temperature to (1) decompose a portion of the polymeric material and (2) cause the soluble precursor compound to react to form the plurality of nanoparticles comprising the second metal, thereby forming a brown part corresponding to the 3D object, wherein the brown part comprises a different portion of the polymeric material, the plurality of particles comprising the first metal, and the plurality of nanoparticles comprising the second metal, and wherein one or more of the plurality of nanoparticles decorate a particle of the plurality of particles; and (d) heating the 3D object at a sintering temperature to form a densified 3D metal object.

In some embodiments, the feedstock further comprises an inert filler. In some embodiments, the inert filler is configured to decompose at a second temperature that is less than the first temperature. In some embodiments, the inert filler is configured to dissolve in a solvent.

In some embodiments, at a temperature less than or equal to the sintering temperature, the particle decorated with the one or more of the plurality of nanoparticles are configured to convert to particles with a liquid coating that comprises an alloy comprising the first metal and the second metal.

In some embodiments, the sintering temperature is between about 1000° C. (°C) and about 1080° C.

In another aspect, the present disclosure provides a method for forming a three-dimensional (3D) object, comprising: (a) providing a first body corresponding to the 3D object, wherein the first body comprises: (i) a first plurality of particles comprising a first metal; (ii) a metallic precursor comprising a second metal; and (iii) a polymeric material, wherein the polymeric material encapsulates the first plurality of particles and the metallic precursor; and (b) subjecting the first body to heating at a first temperature sufficient for the second metal of the metallic precursor to form a second plurality of particles, to form a second body corresponding to the 3D object, wherein the second body comprises at least the first plurality of particles and the second plurality of particles.

In some embodiments, the first temperature is sufficient to degrade at least a portion of the polymeric material.

In some embodiments, a melting temperature of the first metal is higher than a melting temperature of the second metal, and wherein the melting temperature of the second metal is higher than the first temperature.

In some embodiments, a particle of the second plurality of particles is configured to couple to a particle of the first plurality of particles at the first temperature.

In some embodiments, an average diameter of a particle of the second plurality of particles is smaller than an average diameter of a particle of the first plurality of particles.

In some embodiments, the method further comprises subjecting the second body to a second temperature higher than the first temperature, wherein the second temperature is sufficient to melt at least a portion of the second plurality of particles, thereby forming the 3D object. In some embodiments, the second temperature is sufficient to form an alloy comprising the first metal and the second metal. In some embodiments, a melting temperature of the first metal is higher than the second temperature.

In some embodiments, the method further comprises a 3D printing system and a mixture comprising (i) the first plurality of particles, (ii) the metallic precursor, and (iii) a polymer precursor configured to form the polymeric material, to print at least a portion of the first body.

In another aspect, the present disclosure provides a method for forming a three-dimensional (3D) object, comprising: (a) providing a body corresponding to the 3D object, wherein the body comprises: (i) a plurality of core-shell particles, wherein a core-shell particle of the plurality of core-shell particles comprises (1) a core comprising a first metal and (2) a shell comprising a second metal; and (ii) a polymeric material, wherein the polymeric material encapsulates the plurality of core-shell particles; and (b) subjecting the body to heating at a first temperature sufficient to melt at least a portion of the shell of the core-shell particle, to form the 3D object, wherein the first temperature is lower than a melting temperature of the first metal.

In some embodiments, the first temperature is sufficient to form an alloy comprising the first metal and the second metal.

In some embodiments, the melting temperature of the first metal is higher than the melting temperature of the second metal.

In some embodiments, the method further comprises, prior to (b), subjecting the body at a second temperature lower than the first temperature, to degrade at least a portion of the polymeric material.

In some embodiments, the method further comprises using a 3D printing system and a mixture comprising (i) the plurality of core-shell particles and (ii) a polymer precursor configured to form the polymeric material, to print at least a portion of the body.

In some embodiments, an average thickness of the shell is less than half of an average diameter of the core-shell particle.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 schematically illustrates smaller particles disposed adjacent to surfaces of lager particles;

FIG. 2 schematically illustrates a cross-section of a core-shell particle;

FIG. 3 shows an example flowchart of a method for printing a 3D object;

FIG. 4 schematically illustrates an example of a mixture for 3D printing;

FIG. 5 shows an example flowchart of another method for printing a 3D object;

FIG. 6 schematically illustrates an example of a green body formed by a 3D printing method;

FIG. 7 shows an example of a 3D printing system;

FIG. 8 shows an example of another 3D printing system; and

FIG. 9 shows a computer system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Various embodiments of the present disclosure are illustrated in the context of three-dimensional (3D) printing (e.g., stereolithography (SLA) or digital light processing (DLP)) of metal and/or ceramic parts.

Particle size is an indirect measure, obtained by a model that transforms, in an abstract way, a real particle shape into a simple and standardized shape, such as a sphere, where a size parameter such as diameter makes sense. But collections of particles are almost always polydisperse, meaning that the particles have different sizes. The notion of particle size distribution reflects this polydispersity. As used herein, “particle size,” in reference to a collection of particles, refers to the d₅₀ of the particles, which is the diameter for which 50 percent (%) of the particles have a smaller diameter and 50% percent have a larger diameter. The d₅₀ is also be the median diameter for a collection of particles.

The terms “feedstock,” “resin,” and “mixture,” as used interchangeably herein, generally refer to the raw material that is used in a 3D printing process. A feedstock may contain polymer precursors. The feedstock may also contain one or more additional components, such as, for examples, photoinitiators, photoinhibitors, ultraviolet (UV) absorbers, or inert fillers. The term “composite feedstock” is used herein to refer to a feedstock that contains (i) metal, ceramic, polymeric, and/or other suspended particles and (ii) at least one additional component (e.g., polymeric precursors).

The feedstock may include a photoactive mixture. The photoactive mixture may include a polymerizable and/or cross-linkable component (i.e., a polymer precursor) and a photoinitiator that activates curing of the polymerizable and/or cross-linkable component, to thereby subject the polymerizable and/or cross-linkable component to polymerization and/or cross-linking. The polymer precursor may comprise monomers, oligomers, and/or polymers. Such polymerization and/or cross-linking of the polymerizable and/or cross-linkable component, respectively, may form a polymeric material. The photoactive mixture may include a photoinhibitor that inhibits curing of the polymerizable and/or cross-linkable component. The 3D printing may be performed with greater than or equal to about 1, 2, 3, 4, 5, 6, 7, 8, 9, 10 or more mixtures. As an alternative, the 3D printing may be performed with less than or equal to about 10, 9, 8, 7, 6, 5, 4, 3, 2 mixtures, or no mixture (e.g., a single component). A plurality of mixtures may be used for printing a multi-material 3D object.

The term “photoinitiation,” as used herein, generally refers to a process of subjecting a portion of a mixture, such as a feedstock for a 3D printing process, to at least a portion of an electromagnetic radiation (i.e., photoradiation), such as photoradiation or light (photoinitiator light), to cure a photoactive resin in the portion of the mixture. The photoradiation may have a wavelength that activates a photoinitiator that initiates curing of a polymer precursor in the feedstock.

The term “photoinhibition,” as used herein, generally refers to a process of subjecting a portion of a mixture, such as a feedstock for a 3D printing process, to at least a portion of an electromagnetic radiation, such as photoradiation or light (photoinhibitor light), to inhibit curing of a polymer precursor in the portion of the mixture. The photoradiation may have a wavelength that activates a photoinhibitor that inhibit curing of a polymer precursor. The photoinhibition light and the photoinitiation light may have different wavelengths. In some examples, the photoinhibition light and the photoinitiation light may be projected from the same optical source. In some examples, the photoinhibition light and the photoinitiation light may be projected from different optical sources.

The term “particle,” as used herein, generally refers to any particulate material that may be melted or sintered (e.g., not completely melted). The particulate material may be in powder form. The particles may be inorganic materials. The inorganic materials may be metallic (e.g., aluminum or titanium), intermetallic (e.g., steel alloys), ceramic (e.g., metal oxides) materials, or any combination thereof. In some cases, the term “metal” or “metallic” may refer to both metallic and intermetallic materials. The metallic materials may include ferromagnetic metals (e.g., iron and/or nickel). The particles may have various shapes and sizes. For example, a particle may be in the shape of a sphere, cuboid, or disc, or any partial shape or combination of shapes thereof. The particle may have a cross-section that is circular, triangular, square, rectangular, pentagonal, hexagonal, or any partial shape or combination of shapes thereof. Upon heating, the particles may sinter (or coalesce) into a solid or porous object that may be at least a portion of a larger 3D object or an entirety of the 3D object. The 3D printing may be performed with at least about 1, 2, 3, 4, 5, 6, 7, 8, 9, 10 or more types of particles. As an alternative, the 3D printing may be performed with less than or equal to about 10, 9, 8, 7, 6, 5, 4, 3, 2, or 1 particle, or no particles. In some cases, a particle of the present disclosure may be a core-shell particle.

Any particle (e.g., a metal particle) disclosed herein can be characterized by a size (e.g., an average diameter). An average particle size may be at least about 0.1 nanometer (nm), 0.2 nm, 0.3 nm, 0.4 nm, 0.5 nm, 0.6 nm, 0.7 nm, 0.8 nm, 0.9 nm, 1 nm, 2 nm, 3 nm, 4 nm, 5 nm, 6 nm, 7 nm, 8 nm, 9 nm, 10 nm, 15 nm, 20 nm, 25 nm, 30 nm, 35 nm, 40 nm, 45 nm, 50 nm, 60 nm, 70 nm, 80 nm, 90 nm, 100 nm, 200 nm, 300 nm, 400 nm, 500 nm, 600 nm, 700 nm, 800 nm, 900 nm, 1 micrometer (µm), 2 µm, 3 µm, 4 µm, 5 µm, 6 µm, 7 µm, 8 µm, 9 µm, 10 µm, 20 µm, 30 µm, 40 µm, 50 µm, 60 µm, 70 µm, 80 µm, 90 µm, 100 µm, 200 µm, 300 µm, 400 µm, 500 µm, or more. The average particle size may be at most about 500 µm, 400 µm, 300 µm, 200 µm, 100 µm, 90 µm, 80 µm, 70 µm, 60 µm, 50 µm, 40 µm, 30 µm, 20 µm, 10 µm, 9 µm, 8 µm, 7 µm, 6 µm, 5 µm, 4 µm, 3 µm, 2 µm, 1 µm, 900 nm, 800 nm, 700 nm, 600 nm, 500 nm, 400 nm, 300 nm, 200 nm, 100 nm, 90 nm, 80 nm, 70 nm, 60 nm, 50 nm, 40 nm, 30 nm, 20 nm, 10 nm, 9 nm, nm, 7 nm, 6 nm, 5 nm, 4 nm, 3 nm, 2 nm, 1 nm, 0.9 nm, 0.8 nm, 0.7 nm, 0.6 nm, 0.5 nm, 0.4 nm, 0.3 nm, 0.2 nm, 0.1 nm, or less.

The metallic materials of the particles may include one or more materials selected from aluminum, calcium, magnesium, barium, scandium, titanium, vanadium, chromium, manganese, iron, cobalt, nickel, copper, zinc, yttrium, niobium, molybdenum, ruthenium, rhodium, silver, cadmium, actinium, and gold. The particles may comprise a rare earth element. The rare earth element may include one or more materials selected from scandium, yttrium, and elements of the lanthanide series having atomic numbers from 57-71.

The intermetallic materials of the particles may be a solid-state compound exhibiting metallic bonding, defined stoichiometry, and/or ordered crystal structure (i.e., alloys). The intermetallic materials may be in prealloyed powder form. Examples of such prealloyed powders may include, but are not limited to, brass (copper and zinc), bronze (copper and tin), duralumin (aluminum, copper, manganese, and/or magnesium), gold alloys (gold and copper), rose-gold alloys (gold, copper, and zinc), nichrome (nickel and chromium), and stainless steel (iron, carbon, and additional elements including manganese, nickel, chromium, molybdenum, boron, titanium, silicon, vanadium, tungsten, cobalt, and/or niobium). The prealloyed powders may include superalloys. The superalloys may include two or more materials selected from iron, nickel, cobalt, chromium, tungsten, molybdenum, tantalum, niobium, titanium, and aluminum.

The ceramic materials for the particles may comprise metal (e.g., aluminum, titanium, etc.), non-metal (e.g., oxygen, nitrogen, etc.), and/or metalloid (e.g., germanium, silicon, etc.) atoms primarily held in ionic and covalent bonds. Examples of the ceramic materials include, but are not limited to, an aluminide, boride, beryllia, carbide, chromium oxide, hydroxide, sulfide, nitride, mullite, kyanite, ferrite, titania, zirconia, yttria, and magnesia.

The term “soluble metal precursor compound” is used herein to refer to a metal compound, such as an organometallic compound or a metal salt, that can be dissolved in a 3D printing feedstock to form a miscible, uniformly distributed part of the feedstock. Such soluble metal precursor compounds do not scatter photoradiation used in the 3D printing process. Upon debinding or sintering, soluble metal precursor compounds undergo reactions through which metallic nanoparticles particles are formed.

The term “green body,” as used herein, generally refers to a 3D object that includes a polymeric material matrix in which a plurality of particles (e.g., metal, ceramic, cermet, inorganic carbon, or a combination thereof) is encapsulated. The particles may be configured for sintering or melting. The green body may be self-supporting. The green body may be heated in a heater (e.g., a furnace) to burn off at least a portion of the polymeric material. Some of the metal, ceramic, and/or cermet particles may begin to coalesce during this process.

The term “brown body,” as used herein, generally refers to a green body that has undergone partial debinding, that is, has been treated, such as by solvent treatment, heat treatment, or pressure treatment, to remove at least a portion (e.g., 20% to 95%) of the polymeric material within the green body. The brown body retains the metal, ceramic, and/or cermet particles of the green body and still held together with a certain amount of organic binder from the original binder formulation. The particles may be configured for sintering or melting. The brown body may be self-supporting. The brown body may be heated in a heater (e.g., a furnace) to burn off at least a portion of any remaining polymeric material and to coalesce and densify the metal, ceramic, and/or cermet particles into a finished 3D object.

Feedstocks used for 3D printing may contain components such as polymer precursors, photoinitiators, and suspended particles. Some 3D printing feedstocks may also include additional components such as, for example, inert fillers and photoinhibitors. The suspended particles may contain metal, ceramic or cermet materials.

### Overview

During a 3D printing process, photoradiation may penetrate deep enough into a feedstock to cure or print a layer and bond it to a previously printed layer. Jacobs (P.F. Jacobs, Rapid Prototyping and Manufacturing: Fundamentals of Stereolithography, Soc. of Mechanical Engineers, 1992) derived an expression for the curing depth (l) based on the Beer-Lambert law and is given as:

$$l = {d}_{p} l n \left(\frac{E}{{E}_{c}}\right)$$

where E is the amount of energy transmitted at the incident surface, E_{c} is the amount of energy required to cure the polymer, and dₚ is the penetration depth that is related to the attenuation of light in the material. Generally, the curing depth ranges anywhere from 0.2 to 5.0 times the penetration depth. In most 3D printing applications, a light attenuating species is added to achieve adequate resolution and prevent undesirable curing in previously cured layers.

Conversely, when metal particles, ceramic particles, cermet particles, and/or other highly scattering components are added to a feedstock to form a composite feedstock, it is challenging to obtain a cured layer that is sufficiently thick. Griffith and Halloran (Griffith, M. L. & Halloran, J. W., “Scattering of ultraviolet radiation in turbid suspensions,” J. Appl. Phys. 81, 2538-2546 (1997)) showed that for mixtures of polymer precursors (e.g., photopolymers) and ceramic particles, the penetration depth can be expressed as:

$${d}_{p} = \frac{2 \left〈d\right〉}{30 Q ϕ}$$

where Φ is the volume fraction of the ceramic particles, Q is the scattering efficiency of the composite feedstock, and <d> is the size of the ceramic particles estimated as the harmonic mean of the particle size distribution, where smaller particles are more highly weighted and have a larger influence than larger particles.

The refractive indices (n) for polymer precursors (e.g., photopolymers) and micron-scale suspended particles, such as metal, ceramic, or cermet particles, can be very different. For composite feedstocks that contain mixtures of photopolymer and micron-scale particles, Mie scattering dominates, and the scattering efficiency Q is approximately 2. The penetration depth, as expressed in equation (2), may depend on volume fraction and particle size. For high volume fractions, the penetration depth approaches (and can go below) the harmonic mean of the particle size distribution (<d>). Thus, the (harmonic) mean particle size is essentially the upper limit on the penetration depth that can be expected in 3D printing with highly loaded systems, (i.e., systems with suspended particles concentrations of 35 vol% or more).

In DLP or SLA 3D printing, the desired printed layer thickness is rarely less than 10 µm and in some cases ranges from 50 to 100 µm or more. Using thinner layers increases the amount of time it takes to print an entire part, as many more layers are needed than if the layers were thicker. Thus, to achieve a desired layer thicknesses, the (harmonic) mean particle size may be greater than or equal to 5 µm and may be as large as 100 µm or more, as, in general, the thickness of a layer is greater than the largest particle diameter in the feedstock.

3D printed green body parts that contain metal particles are usually sintered to densify into finished parts. During the sintering process, the metal or ceramic particles in the green part join together; the green part loses porosity and densifies to become a monolithic component. Green parts made of fine particles with sizes in the range of 500 nm to 10 µm can usually achieve densities of 98% or better under optimum sintering conditions. On the other hand, under the same sintering conditions, green parts made of larger particles with sizes in the range of 15 µm to 45 µm can barely achieve 75% density and require a much longer sintering time to reach even 90% density. Densification reaches a plateau, and additional time does not lead to further improvements. Thus, it is desirable for the metal particle sizes in a green body part to be a few microns or less in order to form sintered finished parts that have high densities and good mechanical properties. This is the opposite of what is desired for the 3D printing process itself, where small particle sizes yield undesirable, thin printed layers.

### Compositions for 3D Printing and Methods Thereof

The present disclosure provides compositions and methods for particle (e.g., metal and/or ceramic particles) 3D printing. In some embodiments, the compositions and the methods herein may mitigate the scattering of metal particles to ensure printing of sufficiently thick cured layers. In some embodiments, the compositions and methods herein may allow formation of brown bodies that can be sintered in a reasonable time to yield 3D objects with high material density. In some examples, the compositions may comprise one or more particles for liquid phase sintering.

In some embodiments, a soluble metal precursor compound is added to the feedstock. The soluble metal precursor contains a metal (B). In some cases, metal B can alloy with the metal A in the suspended metal particles in the feedstock (e.g., during sintering). In some cases, metal B and/or alloy AB melts at a temperature that is lower than the melting point of metal A. Such compounds dissolve in the feedstock and do not significantly absorb or scatter the light used to cure the photoactive resin in 3D printing.

In some cases, the feedstock is printed using photoradiation to form a green part that contains metal A particles suspended in a polymer binder that also contains the soluble metal B precursor.

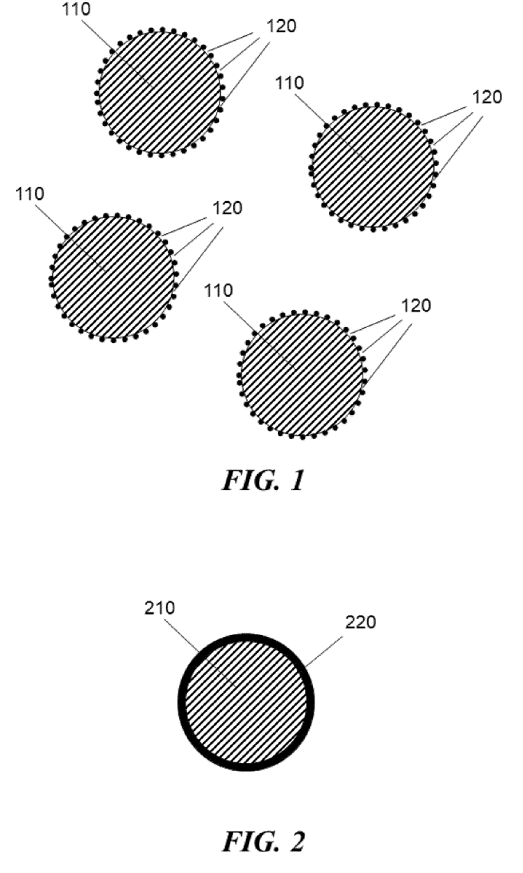

In some cases, the green part undergoes thermal debinding (i.e., heating to remove some or all of the polymer binder) to form a brown part. During debinding, as shown in FIG. 1, nanoparticles 120 of the alloying metal B can form from the soluble metal precursor compound(s) and are deposited on the larger metal A particles 110. The binding interaction between the particles (e.g., nanoparticles) of the metal B and the particles can be non-covalent, e.g., Van der Waals attraction and/or metallic bond (i.e., alloying). In some cases, one or more free metal ions may be deposited on the larger metal A particles 110, and such metal ion(s) may serve as nucleation sites to form the particles (e.g., nanoparticles) 120 of the metal B. During the formation of the particles 120, at least a portion of the metal B in the particles 120 may alloy with the metal A in the particles 110. Alternatively, no alloying may occur between the metal A and metal B during the formation of the particles 120 adjacent to the particles 110. In some cases, the metal A particles 110 have a d₅₀ between 5 µm and 60 µm. In some cases, the nanoparticles 120 have a d₅₀ between 10 nm and 500 nm.

The decomposition temperature for decomposing the soluble metal precursor compound may be at least about 200° C. (°C), 250° C., 300° C., 350° C., 400° C., 450° C., 500° C., 550° C., 600° C., 650° C., 700° C., or more. The decomposition temperature for decomposing the soluble metal precursor compound may be at most about 700° C., 650° C., 600° C., 550° C., 500° C., 450° C., 400° C., 350° C., 300° C., 250° C., 200° C., or less. In an example, the decomposition temperature for decomposing the soluble metal precursor compound may be about 450° C. The transformation temperature for transforming the metal precursor compounds (or free metal ions thereof) into one or more nanoparticles may be at least about 500° C., 550° C., 600° C., 650° C., 700° C., 750° C., 800° C., 850° C., 900° C., 950° C., 1000° C., 1050° C., 1100° C., or more. The transformation temperature for transforming the metal precursor compounds (or free metal ions thereof) into one or more nanoparticles may be at most about 1100° C., 1050° C., 1000° C., 950° C., 900° C., 850° C., 800° C., 750° C., 700° C., 650° C., 600° C., 550° C., 500° C., or less. In an example, the transformation temperature for transforming the metal precursor compounds (or free metal ions thereof) into one or more nanoparticles may be about 850° C.

In some cases, the brown part is heated at a sintering temperature that is higher than the debinding temperature. In some cases, the metal B nanoparticles serve to increase the surface energy of the metal A particles, which helps to drive the sintering process. In some cases, the metal B nanoparticles melt at a temperature that is lower than the melting point of the metal A particles and is lower than or equal to the sintering temperature. In some cases, the metal B nanoparticles on the metal A particles form AB alloy coatings that melt at a temperature that is lower than the melting point of the metal A particles and is lower than or equal to the sintering temperature. In both arrangements, the metal A particles may be coated with a liquid phase during heat treatment for sintering. Such a liquid phase coating can act as a liquid sintering aid to ensure densification of the metal A particles through providing a low energy pathway for movement of metal A atoms and by supplying metal B and/or alloy AB material for filling voids. The resulting finished 3D printed part contains mainly metal A but may also contain metal B and/or AB alloys.

The processing temperature for heating (e.g., sintering) the green part or brown part may be at least about 300° C., 350° C., 400° C., 450° C., 500° C., 550° C., 600° C., 650° C., 700° C., 750° C., 800° C., 850° C., 900° C., 950° C., 1000° C., 1050° C., 1100° C., 1150° C., 1200° C., 1250° C., 1300° C., 1350° C., 1400° C., 1450° C., 1500° C., 1550° C., 1600° C., 1700° C., 1800° C., 1900° C., 2000° C., 2100° C., 2200° C., 2300° C., 2400° C., 2500° C., or more. The processing temperature for heating (e.g., sintering) the green part or brown part may be at most about 2500° C., 2400° C., 2300° C., 2200° C., 2100° C., 2000° C., 1900° C., 1800° C., 1700° C., 1600° C., 1550° C., 1500° C., 1450° C., 1400° C., 1350° C., 1300° C., 1250° C., 1200° C., 1150° C., 1100° C., 1050° C., 1000° C., 950° C., 900° C., 850° C., 800° C., 750° C., 700° C., 650° C., 600° C., 550° C., 500° C., 450° C., 400° C., 350° C., 300° C., or less. In some cases, the processing temperature for heating (e.g., sintering) the green part or brown part may be at least about 900° C. or more. In an example, the green part or brown part may comprise silver, and the processing temperature for heating (e.g., sintering) the green part or brown part may be at least about 962° C. or more.

In some examples, the processing temperature for heating (e.g., sintering) the green part or brown part may be about 900° C. to about 1,200° C. The processing temperature for heating (e.g., sintering) the green part or brown part may be at least about 900° C. The processing temperature for heating (e.g., sintering) the green part or brown part may be at most about 1,200° C. The processing temperature for heating (e.g., sintering) the green part or brown part may be about 900° C. to about 930° C., about 900° C. to about 960° C., about 900° C. to about 980° C., about 900° C. to about 1,000° C., about 900° C. to about 1,020° C., about 900° C. to about 1,040° C., about 900° C. to about 1,060° C., about 900° C. to about 1,080° C., about 900° C. to about 1,100° C., about 900° C. to about 1,150° C., about 900° C. to about 1,200° C., about 930° C. to about 960° C., about 930° C. to about 980° C., about 930° C. to about 1,000° C., about 930° C. to about 1,020° C., about 930° C. to about 1,040° C., about 930° C. to about 1,060° C., about 930° C. to about 1,080° C., about 930° C. to about 1,100° C., about 930° C. to about 1,150° C., about 930° C. to about 1,200° C., about 960° C. to about 980° C., about 960° C. to about 1,000° C., about 960° C. to about 1,020° C., about 960° C. to about 1,040° C., about 960° C. to about 1,060° C., about 960° C. to about 1,080° C., about 960° C. to about 1,100° C., about 960° C. to about 1,150° C., about 960° C. to about 1,200° C., about 980° C. to about 1,000° C., about 980° C. to about 1,020° C., about 980° C. to about 1,040° C., about 980° C. to about 1,060° C., about 980° C. to about 1,080° C., about 980° C. to about 1,100° C., about 980° C. to about 1,150° C., about 980° C. to about 1,200° C., about 1,000° C. to about 1,020° C., about 1,000° C. to about 1,040° C., about 1,000° C. to about 1,060° C., about 1,000° C. to about 1,080° C., about 1,000° C. to about 1,100° C., about 1,000° C. to about 1,150° C., about 1,000° C. to about 1,200° C., about 1,020° C. to about 1,040° C., about 1,020° C. to about 1,060° C., about 1,020° C. to about 1,080° C., about 1,020° C. to about 1,100° C., about 1,020° C. to about 1,150° C., about 1,020° C. to about 1,200° C., about 1,040° C. to about 1,060° C., about 1,040° C. to about 1,080° C., about 1,040° C. to about 1,100° C., about 1,040° C. to about 1,150° C., about 1,040° C. to about 1,200° C., about 1,060° C. to about 1,080° C., about 1,060° C. to about 1,100° C., about 1,060° C. to about 1,150° C., about 1,060° C. to about 1,200° C., about 1,080° C. to about 1,100° C., about 1,080° C. to about 1,150° C., about 1,080° C. to about 1,200° C., about 1,100° C. to about 1,150° C., about 1,100° C. to about 1,200° C., or about 1,150° C. to about 1,200° C. The processing temperature for heating (e.g., sintering) the green part or brown part may be about 900° C., about 93° C., about 960° C., about 980° C., about 1,000° C., about 1,020° C., about 1,040° C., about 1,060° C., about 1,080° C., about 1,100° C., about 1,150° C., or about 1,200° C.

A melting temperature of the metal B or the AB alloy may be the same as the melting temperature of the metal A. Alternatively, the melting temperature of the metal B or the AB alloy may be lower than the melting temperature of the metal A. In some cases, the melting temperature of the metal B or the AB alloy may be lower than the melting temperature of the metal A by at least about 0.1 degree C (°C), 0.2° C., 0.3° C., 0.4° C., 0.5° C., 0.6° C., 0.7° C., 0.8° C., 0.9° C., 1° C., 1.5° C., 2° C., 3° C., 4° C., 5° C., 6° C., 7° C., 8° C., 9° C., 10° C., 15° C., 20° C., 25° C., 30° C., 35° C., 40° C., 45° C., 50° C., 60° C., 70° C., 80° C., 90° C., 100° C., 110° C., 120° C., 130° C., 140° C., 150° C., 200° C., 300° C., 400° C., 500° C., or more. In some cases, the melting temperature of the metal B or the AB alloy may be lower than the melting temperature of the metal A by at most about 500° C., 400° C., 300° C., 200° C., 150° C., 140° C., 130° C., 120° C., 110° C., 100° C., 90° C., 80° C., 70° C., 60° C., 50° C., 45° C., 40° C., 35° C., 30° C., 25° C., 20° C., 15° C., 10° C., 9° C., 8° C., 7° C., 6° C., 5° C., 4° C., 3° C., 2° C., 1.5° C., 1° C., 0.9° C., 0.8° C., 0.7° C., 0.6° C., 0.5° C., 0.4° C., 0.3° C., 0.2° C., 0.1° C., or less.

At least a portion of the metal A in the metal A particle may alloy with the metal B in the metal B particle to form the AB alloy (e.g., the AB alloy coating). In some cases, at least 0.1%, 0.2%, 0.3%, 0.4%, 0.5%, 0.6%, 0.7%, 0.8%, 0.9%, 1%, 1.5%, 2%, 3%, 4%, 5%, 6%, 7%, 8%, 9 %, 10%, 15%, 20%, 30%, 40%, 50%, 60%, 70%, 80%, 90%, 95%, or more of the metal A in the metal A particle may alloy with the metal B in the metal B particle to form the AB alloy. In some cases, at most 100%, 95%, 90%, 80%, 70%, 60%, 50%, 40%, 30%, 20%, 15%, 10%, 9%, 8%, 7%, 6%, 5%, 4%, 3%, 2%, 1%, 0.9%, 0.8%, 0.7%, 0.6%, 0.5%, 0.4%, 0.3%, 0.2%, 0.1%, or less of the metal A in the metal A particle may alloy with the metal B in the metal B particle to form the AB alloy.

An average diameter of the metal A particle may be the same as an average diameter of the metal B particle. Alternatively, the average diameter of the metal A particle may be different than the average diameter of the metal B particle. In some cases, the average diameter of the metal A particle may be less than the average diameter of the metal B particle. In some cases, the average diameter of the metal A particle may be greater than the average diameter of the metal B particle. The average diameter of the metal A particle may be greater than the average diameter of the metal B particle by at least 1-fold, 1.5-fold, 2-fold, 3-fold, 4-fold, 5-fold, 6-fold, 7-fold, 8-fold, 9-fold, 10-fold, 11-fold, 12-fold, 13-fold, 14-fold, 15-fold, 16-fold, 17-fold, 18-fold, 19-fold, 20-fold, 25-fold, 30-fold, 35-fold, 40-fold, 45-fold, 50-fold, 60-fold, 70-fold, 80-fold, 90-fold, 100-fold, 150-fold, 200-fold, 300-fold, 400-fold, 500-fold, or more. The average diameter of the metal A particle may be greater than the average diameter of the metal B particle by at most 500-fold, 400-fold, 300-fold, 200-fold, 150-fold, 100-fold, 90-fold, 80-fold, 70-fold, 60-fold, 50-fold, 45-fold, 40-fold, 35-fold, 30-fold, 25-fold, 20-fold, 19-fold, 18-fold, 17-fold, 16-fold, 15-fold, 14-fold, 13-fold, 12-fold, 11-fold, 10-fold, 9-fold, 8-fold, 7-fold, 6-fold, 5-fold, 4-fold, 3-fold, 2-fold, 1.5-fold, 1-fold, or less.

In some examples, the average diameter of the metal A particle may be about 0.1 µm to about 500 µm. The average diameter of the metal A particle may be at least about 0.1 µm. The average diameter of the metal A particle may be at most about 500 µm. The average diameter of the metal A particle may be about 0.1 µm to about 0.5 µm, about 0.1 µm to about 1 µm, about 0.1 µm to about 5 µm, about 0.1 µm to about 10 µm, about 0.1 µm to about 20 µm, about 0.1 µm to about 40 µm, about 0.1 µm to about 60 µm, about 0.1 µm to about 80 µm, about 0.1 µm to about 100 µm, about 0.1 µm to about 200 µm, about 0.1 µm to about 500 µm, about 0.5 µm to about 1 µm, about 0.5 µm to about 5 µm, about 0.5 µm to about 10 µm, about 0.5 µm to about 20 µm, about 0.5 µm to about 40 µm, about 0.5 µm to about 60 µm, about 0.5 µm to about 80 µm, about 0.5 µm to about 100 µm, about 0.5 µm to about 200 µm, about 0.5 µm to about 500 µm, about 1 µm to about 5 µm, about 1 µm to about 10 µm, about 1 µm to about 20 µm, about 1 µm to about 40 µm, about 1 µm to about 60 µm, about 1 µm to about 80 µm, about 1 µm to about 100 µm, about 1 µm to about 200 µm, about 1 µm to about 500 µm, about 5 µm to about 10 µm, about 5 µm to about 20 µm, about 5 µm to about 40 µm, about 5 µm to about 60 µm, about 5 µm to about 80 µm, about 5 µm to about 100 µm, about 5 µm to about 200 µm, about 5 µm to about 500 µm, about 10 µm to about 20 µm, about 10 µm to about 40 µm, about 10 µm to about 60 µm, about 10 µm to about 80 µm, about 10 µm to about 100 µm, about 10 µm to about 200 µm, about 10 µm to about 500 µm, about 20 µm to about 40 µm, about 20 µm to about 60 µm, about 20 µm to about 80 µm, about 20 µm to about 100 µm, about 20 µm to about 200 µm, about 20 µm to about 500 µm, about 40 µm to about 60 µm, about 40 µm to about 80 µm, about 40 µm to about 100 µm, about 40 µm to about 200 µm, about 40 µm to about 500 µm, about 60 µm to about 80 µm, about 60 µm to about 100 µm, about 60 µm to about 200 µm, about 60 µm to about 500 µm, about 80 µm to about 100 µm, about 80 µm to about 200 µm, about 80 µm to about 500 µm, about 100 µm to about 200 µm, about 100 µm to about 500 µm, or about 200 µm to about 500 µm. The average diameter of the metal A particle may be about 0.1 µm, about 0.5 µm, about 1 µm, about 5 µm, about 10 µm, about 20 µm, about 40 µm, about 60 µm, about 80 µm, about 100 µm, about 200 µm, or about 500 µm.

In some examples, the average diameter of the metal B particle (e.g., from a soluble metal precursor) may be about 1 nm to about 1,000 nm. The average diameter of the metal B particle may be at least about 1 nm. The average diameter of the metal B particle may be at most about 1,000 nm. The average diameter of the metal B particle may be about 1 nm to about 10 nm, about 1 nm to about 100 nm, about 1 nm to about 200 nm, about 1 nm to about 300 nm, about 1 nm to about 400 nm, about 1 nm to about 500 nm, about 1 nm to about 600 nm, about 1 nm to about 700 nm, about 1 nm to about 800 nm, about 1 nm to about 900 nm, about 1 nm to about 1,000 nm, about 10 nm to about 100 nm, about 10 nm to about 200 nm, about 10 nm to about 300 nm, about 10 nm to about 400 nm, about 10 nm to about 500 nm, about 10 nm to about 600 nm, about 10 nm to about 700 nm, about 10 nm to about 800 nm, about 10 nm to about 900 nm, about 10 nm to about 1,000 nm, about 100 nm to about 200 nm, about 100 nm to about 300 nm, about 100 nm to about 400 nm, about 100 nm to about 500 nm, about 100 nm to about 600 nm, about 100 nm to about 700 nm, about 100 nm to about 800 nm, about 100 nm to about 900 nm, about 100 nm to about 1,000 nm, about 200 nm to about 300 nm, about 200 nm to about 400 nm, about 200 nm to about 500 nm, about 200 nm to about 600 nm, about 200 nm to about 700 nm, about 200 nm to about 800 nm, about 200 nm to about 900 nm, about 200 nm to about 1,000 nm, about 300 nm to about 400 nm, about 300 nm to about 500 nm, about 300 nm to about 600 nm, about 300 nm to about 700 nm, about 300 nm to about 800 nm, about 300 nm to about 900 nm, about 300 nm to about 1,000 nm, about 400 nm to about 500 nm, about 400 nm to about 600 nm, about 400 nm to about 700 nm, about 400 nm to about 800 nm, about 400 nm to about 900 nm, about 400 nm to about 1,000 nm, about 500 nm to about 600 nm, about 500 nm to about 700 nm, about 500 nm to about 800 nm, about 500 nm to about 900 nm, about 500 nm to about 1,000 nm, about 600 nm to about 700 nm, about 600 nm to about 800 nm, about 600 nm to about 900 nm, about 600 nm to about 1,000 nm, about 700 nm to about 800 nm, about 700 nm to about 900 nm, about 700 nm to about 1,000 nm, about 800 nm to about 900 nm, about 800 nm to about 1,000 nm, or about 900 nm to about 1,000 nm. The average diameter of the metal B particle may be about 1 nm, about 10 nm, about 100 nm, about 200 nm, about 300 nm, about 400 nm, about 500 nm, about 600 nm, about 700 nm, about 800 nm, about 900 nm, or about 1,000 nm.

In an exemplary embodiment, suspended metal A particles contain copper and metal B nanoparticles (e.g., derived from a plurality of the soluble metallic precursor compounds as disclosed herein) contain silver. While there are many metal materials that can alloy with copper, many such alloys have properties that may be undesirable in a finished copper 3D printed part. In some cases, silver may be used due to the high electrical and thermal conductivity of both silver itself and copper-silver alloys. The melting point of silver is 962° C. which is lower than typical copper sintering temperatures around 1050° C. In addition, the silver-copper system has a eutectic, (i.e., a low melting temperature) for the silver-copper alloy. Thus, silver-copper alloys are liquid at 780° C., even lower than silver itself and certainly lower than typical sintering temperatures. In some cases, silver precursor compounds may be used in any 3D printing feedstock as disclosed herein. In some examples, the silver precursor compounds may be soluble in any 3D printing feedstock as disclosed herein. Examples of the silver precursor compounds can include, but are not limited to, silver formate, silver acetate, silver trifluoroacetate, silver 1,3-acetonedicarboxylate, silver acetoacetate, silver oxalate, silver lactate, silver malonate, silver malate, silver maleate, silver fumarate, silver glyoxylate, silver pyruvate, silver succinate, silver glutalate, silver gluconate, silver picrate, silver citrate, silver iminodiacetate, silver nitrilotriacetate, silver ethylenediaminetetraacetate, silver neodecanoate, silver stearate, silver oxide, silver carbonate, silver nitrate, silver citrate hydrate, and micro- or nanoparticles of silver. Example structures of soluble silver precursor compounds that can be added to 3D printing feedstocks are shown in Table I.

TABLE I

Exemplary Soluble Silver Precursor Compounds

| | |
|---|---|
| Compound | Structure |
| Silver carbonate | 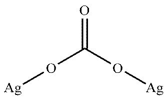 |
| Silver nitrate | 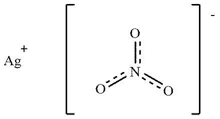 |
| Silver acetate | 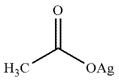 |
| Silver citrate hydrate | 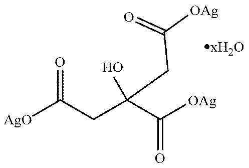 |
| Silver lactate | 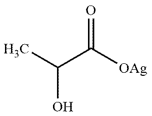 |

Similar soluble metal compounds may be found for other metal particles and alloying systems. Examples of such systems can include, but are not limited to, zinc, indium, lead, magnesium, aluminum, and tin. Examples of zinc precursor compounds can include, but are not limited to, zinc acetate, zinc acetate dehydrate, zinc acetate anhydrous, zinc carbonate, zinc nitrate, zinc nitrate hexahydrate, zinc lactate, zinc oxide, zinc chloride, zinc chloride hydrate, zinc hydroxide, zinc citrate hydrate, zinc sulfate heptahydarate, zinc sulfate monohydarate, and micro- or nanoparticles of zinc. Examples of indium precursor compounds can include, but are not limited to, indium acetate, indium carbonate, indium chelate, indium chloride, indium glutanate, indium gluconate, indium iodide, indium phosphate, indium palmitate, indium sulphate, and micro- or nanoparticles of indium. Examples of lead precursor compounds can include, but are not limited to, lead oxide, lead chloride, lead nitrate, lead acetate, lead sulphate, lead carbonate, lead hydroxide, and micro- or nanoparticles of lead. Examples of magnesium precursor compounds can include, but are not limited to, magnesium alkoxide, acetylacetone magnesium, magnesium nitrate, magnesium hydroxide, magnesium carbonate, magnesium chloride, magnesium sulfate, magnesium oxalate, magnesium acetate, and micro- or nanoparticles of magnesium. Examples of aluminum precursor compounds can include, but are not limited to, aluminum hydroxide, aluminum alkoxide, aluminum citrate, aluminum acetate, aluminum carbonate, aluminum (meth)acrylate, aluminum nitrate, aluminum acetylacetonate, aluminum halide, aluminum thiocarbamate, aluminum sulfonate, aluminum undecylate, aluminum borate, and micro- or nanoparticles of aluminum. Examples of tin precursor compounds can include, but are not limited to, tin hydroxide, tin alkoxide, tin citrate, tin acetate, tin carbonate, tin (meth)acrylate, tin nitrate, tin acetylacetonate, tin halide (e.g., tin chloride, tin fluoride, and the like), tin thiocarbamate, tin sulfonate, tin undecylate, tin borate, and micro- or nanoparticles of tin. Examples of nickel precursor compounds can include, but are not limited to, nickel oxide, nickel sulfate, nickel nitrate, nickel chloride, nickel bromide, nickel fluoride, nickel acetate, nickel acetylacetonate, and nickel hydroxide.

Alternatively, suspended metal A particles may comprise a metal that is not copper (e.g., silver) and metal B nanoparticles (e.g., derived from a plurality of the soluble metallic precursor compounds as disclosed herein) may comprise copper. In such case, examples of copper precursor compounds (e.g., soluble copper precursor compounds in a feedstock mixture) can include, but are not limited to, copper formate, copper citrate, copper acetate, copper nitrate, copper acetylacetonate, copper perchlorate, copper chloride, copper sulfate, copper carbonate, and copper hydroxide.

An alloy as provided herein (e.g., an alloy formed of (i) a plurality of particles comprising a first metal and (ii) a second metal derived from a soluble precursor compound) may be an interstitial alloy. Alternatively or in addition to, such alloy may be a substitution alloy.

Non-limiting examples of an alloy as disclosed herein can include, but are not limited to, copper-nickel alloy (e.g., copper-nickel, copper-nickel-tin, copper-nickel-manganese, copper-nickel-manganese-iron, copper-nickel-iron-manganese, copper-nickel-iron-manganese-niobium, copper-nickel-zinc, copper-nickel-zinc-manganese-lead, copper-nickel-zinc-lead, copper-nickel-silver, etc.), copper-silver alloy (e.g., copper-silver, copper-silver-manganese, copper-silver-nickel, copper-silver-nickel-iron, copper-silver-iron, copper-silver-iron-manganese, copper-silver-arsenic, etc.), copper-zinc alloy (e.g., copper-zinc, copper-zinc-nickel, copper-zinc-tin, copper-zinc-tin-aluminum, copper-zinc-aluminum, copper-zinc-aluminum, copper-zinc-aluminum-manganese-iron, copper-zinc-manganese, copper-zinc-manganese-lead, copper-zinc-iron, copper-zinc-silicon, copper-zinc-arsenic, copper-zinc-lead, copper-zinc-lead-aluminum, copper-zinc-lead-nickel-aluminum, etc.), copper-tin alloy (e.g., copper-tin, copper-tin-zinc-nickel, copper-tin-zinc-lead, etc.), copper-manganese alloy (e.g., copper-manganese, copper-manganese-nickel, copper-manganese-nickel-aluminum, etc.), copper-phosphorous alloy, etc.

In some cases, a feedstock mixture of the present disclosure may comprise a first metal and a second metal. In such cases, (1) the first metal may be part of a plurality of particles of the feedstock mixture and (2) the second metal may be part of a soluble metallic precursor compound of the feedstock mixture. For example, the first metal of the plurality of particles may be copper, and the second metal of the soluble metallic precursor may be non-copper (e.g., silver, zinc, nickel, etc.). In another example, the first metal of the plurality of particles may be non-copper and the second metal of the soluble metallic precursor may be copper.

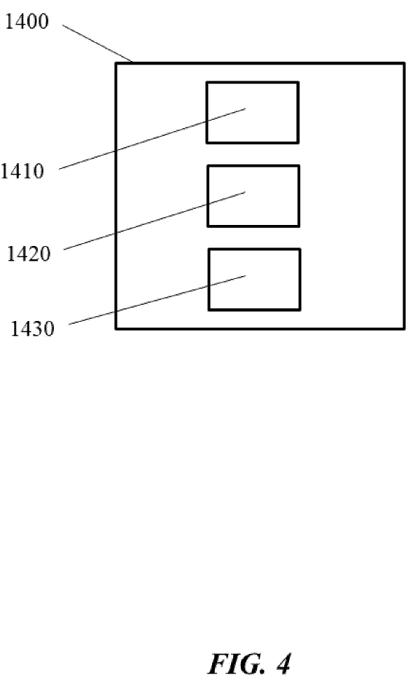

FIG. 4 illustrates an example feedstock mixture for 3D printing, as disclosed herein. The feedstock mixture 1400 may comprise a polymeric precursor 1410 configured to form a polymeric material. The polymeric material may be configured to decompose at a first temperature. The feedstock mixture 1400 may further comprise a first plurality of particles 1420, and each particle of the first plurality of particles 1420 may comprise a first metal. The feedstock mixture 1400 may further comprise a soluble metallic precursor compound 1430 configured to react at a second temperature to form a second plurality of particles comprising a second metal capable of alloying with said first metal.

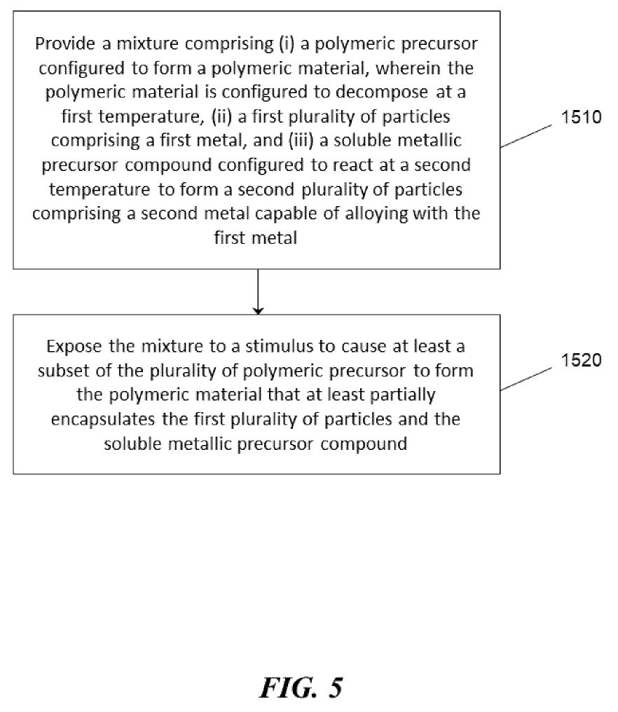

FIG. 5 illustrates a flowchart of an example method for printing at least a portion of a 3D object. The method can comprise providing a mixture comprising (i) a polymeric precursor configured to form a polymeric material, wherein the polymeric material is configured to decompose at a first temperature, (ii) a first plurality of particles comprising a first metal, and (iii) a soluble metallic precursor compound configured to react at a second temperature to form a second plurality of particles comprising a second metal capable of alloying with the first metal (process 1510). The method can further comprise exposing the mixture to a stimulus to cause at least a subset of the plurality of polymeric precursor to form the polymeric material that at least partially encapsulates the first plurality of particles and the soluble metallic precursor compound (process 1520), to form a brown body.

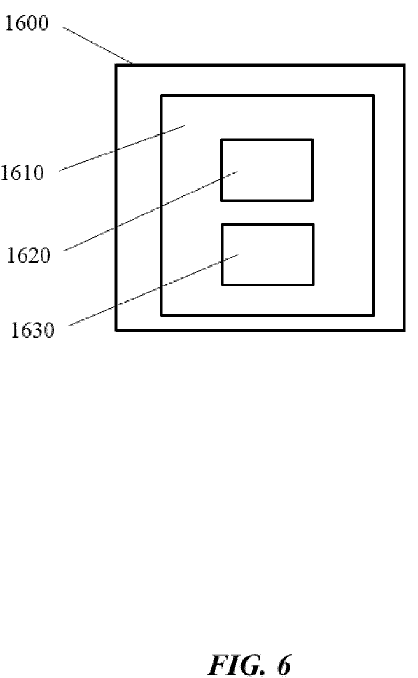

FIG. 6 illustrates an example green body that is formed in accordance to the method illustrated in FIG. 5. According to FIG. 6, the green body 1600 can comprise a polymeric material 1610 configured to decompose at a first temperature. The green body 1600 can further comprise a first plurality of particles 1620 comprising a first metal. The green body 1600 can further comprise a soluble precursor compound 1630 configured to react to form a second plurality of particles comprising a second metal capable of alloying with the first metal. The polymeric material 1610 may encapsulate partial or entirety of the first plurality of particles 1620 and the soluble precursor compound 1630.

In some cases, a feedstock mixture of the present disclosure may comprise a first metal and a second metal. The feedstock mixture may comprise a plurality of heterogeneous particles (e.g., a plurality of core-shell particles), wherein (1) a first portion (or domain) of a heterogeneous particle of the plurality of heterogeneous particles (e.g., a core of a core-shell particle of the plurality of core-shell particles) may comprise the first metal and (2) a second portion (or domain) of the heterogeneous particle (e.g., a shell of the core-shell particle) may comprise the second metal. For example, the first metal of the first portion of the heterogeneous particle (e.g., a core of a core-shell particle) may be copper, and the second metal of the second portion of the heterogeneous particle (e.g., a shell of the core-shell particle) may be non-copper (e.g., silver, zinc, nickel, etc.). In another example, the first metal of the first portion of the heterogeneous particle (e.g., a core of a core-shell particle) may be non-copper, and the second metal of the second portion of the heterogeneous particle (e.g., a shell of the core-shell particle) may be copper. Such feedstock mixture can comprise a polymeric precursor configured to form a polymeric material that encapsulates at least a portion of the plurality of heterogeneous particles. The polymeric material can decompose at a first temperature, and the first metal and the second metal of the plurality of heterogeneous particles may alloy at a second temperature. The first temperature and the second temperature may be different. For example, the first temperature may be lower than the second temperature.

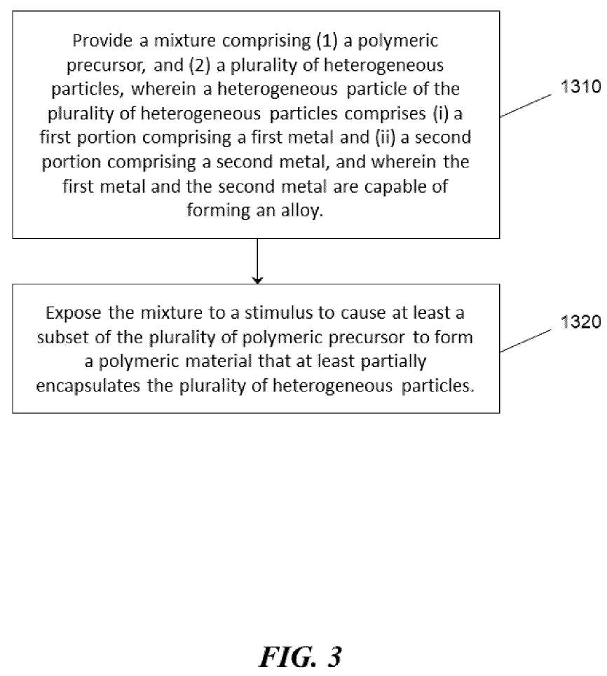

FIG. 3 illustrates a flowchart of an example method for printing at least a portion of a 3D object. The method can comprise providing a mixture comprising (1) a polymeric precursor, and (2) a plurality of heterogeneous particles, wherein a heterogeneous particle of the plurality of heterogeneous particles comprises (i) a first portion comprising a first metal and (ii) a second portion comprising a second metal, and wherein the first metal and the second metal are capable of forming an alloy (process 1310). The method can further comprise exposing the mixture to a stimulus to cause at least a subset of the plurality of polymeric precursor to form a polymeric material that at least partially encapsulates the plurality of heterogeneous particles (process 1320).

An average diameter of the plurality of heterogeneous particles (e.g., a plurality of core-shell particles) may be about 1 µm to about 1,000 µm. The average diameter of the plurality of heterogeneous particles may be at least about 1 µm. The average diameter of the plurality of heterogeneous particles may be at most about 1,000 µm. The average diameter of the plurality of heterogeneous particles may be about 1 µm to about 2 µm, about 1 µm to about 5 µm, about 1 µm to about 10 µm, about 1 µm to about 20 µm, about 1 µm to about 50 µm, about 1 µm to about 100 µm, about 1 µm to about 200 µm, about 1 µm to about 500 µm, about 1 µm to about 1,000 µm, about 2 µm to about 5 µm, about 2 µm to about 10 µm, about 2 µm to about 20 µm, about 2 µm to about 50 µm, about 2 µm to about 100 µm, about 2 µm to about 200 µm, about 2 µm to about 500 µm, about 2 µm to about 1,000 µm, about 5 µm to about 10 µm, about 5 µm to about 20 µm, about 5 µm to about 50 µm, about 5 µm to about 100 µm, about 5 µm to about 200 µm, about 5 µm to about 500 µm, about 5 µm to about 1,000 µm, about 10 µm to about 20 µm, about 10 µm to about 50 µm, about 10 µm to about 100 µm, about 10 µm to about 200 µm, about 10 µm to about 500 µm, about 10 µm to about 1,000 µm, about 20 µm to about 50 µm, about 20 µm to about 100 µm, about 20 µm to about 200 µm, about 20 µm to about 500 µm, about 20 µm to about 1,000 µm, about 50 µm to about 100 µm, about 50 µm to about 200 µm, about 50 µm to about 500 µm, about 50 µm to about 1,000 µm, about 100 µm to about 200 µm, about 100 µm to about 500 µm, about 100 µm to about 1,000 µm, about 200 µm to about 500 µm, about 200 µm to about 1,000 µm, or about 500 µm to about 1,000 µm. The average diameter of the plurality of heterogeneous particles may be about 1 µm, about 2 µm, about 5 µm, about 10 µm, about 20 µm, about 50 µm, about 100 µm, about 200 µm, about 500 µm, or about 1,000 µm.

In some cases, a weight ratio between the first metal (M1) and the second metal (M2) in the feedstock mixture may be greater than about 10:10, 11:9, 12:8, 13:7, 14:6, 15:5, 16:4, 17:3, 18:2, or 19:1 (M1:M2). The weight ratio between the first metal and the second metal (M1:M2) in the feedstock mixture may be between about 10:10 and about 19:1 (e.g., 60:40, 70:30, 80:20, 90:10, 95:5, etc.).

In some cases, a weight ratio between the first metal and the second metal (M1:M2) in the feedstock mixture may be less than about 10:10, 9:11, 8:12, 7:13, 6:14, 5:15, 4:16, 3:17, 2:18, or 1:19. The weight ratio between the first metal and the second metal (M1:M2) in the feedstock mixture may be between about 1:19 and about 10:10 (e.g., 5:95, 10:90, 20:80, 30:70, 40:60, etc.).

In some cases, a weight ratio between the first metal and the second metal (M1:M2) in the feedstock mixture may be about 10:10.

In some cases, an amount of the first metal in the feedstock mixture relative to an amount of the second metal in the feedstock mixture may be at least about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 96%, 97%, 98%, 99%, or more by weight. The amount of the first metal in the feedstock mixture relative to an amount of the second metal in the feedstock mixture may be at most about 99%, 98%, 97%, 96%, 95%, 90%, 85%, 80%, 75%, 70%, 65%, 60%, 55%, 50%, 45%, 40%, 35%, 30%, 25%, 20%, 15%, 10%, 5%, 4%, 3%, 2%, 1%, or less by weight.

In some cases, an amount of the second metal in the feedstock mixture relative to an amount of the first metal in the feedstock mixture may be at least about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 96%, 97%, 98%, 99%, or more by weight. The amount of the second metal in the feedstock mixture relative to an amount of the first metal in the feedstock mixture may be at most about 99%, 98%, 97%, 96%, 95%, 90%, 85%, 80%, 75%, 70%, 65%, 60%, 55%, 50%, 45%, 40%, 35%, 30%, 25%, 20%, 15%, 10%, 5%, 4%, 3%, 2%, 1%, or less by weight.

In some cases, a weight ratio between the first metal (M1) and the second metal (M2) in an alloy formed from the feedstock mixture as disclosed herein may be greater than about 10:10, 11:9, 12:8, 13:7, 14:6, 15:5, 16:4, 17:3, 18:2, or 19:1 (M1:M2). The weight ratio between the first metal and the second metal (M1:M2) in the alloy may be between about 10:10 and about 19:1 (e.g., 60:40, 70:30, 80:20, 90:10, 95:5, etc.).

In some cases, a weight ratio between the first metal and the second metal (M1:M2) in an alloy formed from the feedstock mixture may be less than about 10:10, 9:11, 8:12, 7:13, 6:14, 5:15, 4:16, 3:17, 2:18, or 1:19. The weight ratio between the first metal and the second metal (M1:M2) in the alloy may be between about 1:19 and about 10:10 (e.g., 5:95, 10:90, 20:80, 30:70, 40:60, etc.).

In some cases, a weight ratio between the first metal and the second metal (M1:M2) in an alloy formed from the feedstock mixture may be about 10:10.

In some cases, an amount of the first metal in an alloy formed from the feedstock mixture relative to an amount of the second metal in the alloy may be at least about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 96%, 97%, 98%, 99%, or more by weight. The amount of the first metal in the alloy relative to an amount of the second metal in the alloy may be at most about 99%, 98%, 97%, 96%, 95%, 90%, 85%, 80%, 75%, 70%, 65%, 60%, 55%, 50%, 45%, 40%, 35%, 30%, 25%, 20%, 15%, 10%, 5%, 4%, 3%, 2%, 1%, or less by weight.

In some cases, an amount of the second metal in an alloy formed from the feedstock mixture relative to an amount of the first metal in the alloy may be at least about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 96%, 97%, 98%, 99%, or more by weight. The amount of the second metal in the alloy relative to an amount of the first metal in the alloy may be at most about 99%, 98%, 97%, 96%, 95%, 90%, 85%, 80%, 75%, 70%, 65%, 60%, 55%, 50%, 45%, 40%, 35%, 30%, 25%, 20%, 15%, 10%, 5%, 4%, 3%, 2%, 1%, or less by weight.

In some cases, an atomic number of a first metal as disclosed herein (e.g., a first metal of a plurality of particles that are pre-formed) may be greater than an atomic number of a second metal as disclosed herein (e.g., a second metal of a soluble metallic precursor), by at least 1, 2, 3, 4, 5, or more. For example, the first metal may be copper and the second metal may be nickel. In another example, the first metal may be zinc, and the second metal may be copper. Alternatively, the atomic number of the first metal may be less than the atomic number of the second metal, by at least 1, 2, 3, 4, 5, or more. For example, the first metal may be copper, and the second metal may be zinc. In another example, the first metal may be nickel, and the second metal may be copper.

In some embodiments, liquid phase sintering of 3D printed parts can be achieved. For example. the feedstock can contain a plurality of components, such as, for example, polymer precursors, photoinitiators, suspended metal A particles, etc. Before being added to the feedstock, the suspended metal A particles may be first coated with a thin layer or shell of metal B to form core-shell A/B particles. The metal A and the metal B may be selected such that the metals A and B can alloy to form the alloy AB under sufficient conditions (e.g., heat). An example of such a core-shell particle is shown in FIG. 2 in which a metal A particle 210 is coated with a thin shell 220 of metal B. In some cases, the shell has a thickness between 1% and 10% of the diameter (d₅₀) of the particle. Although the shell 220 is shown in FIG. 2 as continuous, there are other arrangements (not shown) in which the shell 220 is discontinuous and does not completely cover the particle 210. In some cases, metal B can alloy with metal A. In some cases, metal B and/or alloy AB melts at a temperature lower than the melting point of metal A. In some cases, the core-shell particles have a d₅₀ between 5 µm and 60 µm.

In some cases, the feedstock is printed using photoradiation to form a green part that contains core-shell A/B particles suspended in a polymer binder.

In some cases, the green part undergoes thermal debinding (i.e., heating to remove some or all of the polymer binder) to form a brown part.

In some cases, the brown part is heated at a sintering temperature that is higher than the debinding temperature (e.g., the melting temperature of the polymeric material as disclosed herein). In some cases, the metal B shells melt at a temperature that is lower than the melting point of the metal A particles and is lower than or equal to the sintering temperature. In some cases, the metal B shells on the metal A particles form AB alloy coatings that melt at a temperature that is lower than the melting point of the metal A particles and is lower than or equal to the sintering temperature. In both arrangements, the metal A particles may be coated with a liquid phase during heat treatment for sintering. Such a liquid phase coating can act as a liquid sintering aid to ensure densification of the metal A particles through providing a low energy pathway for movement of metal A atoms and by supplying metal B and/or alloy AB material for filling voids. The resulting finished 3D printed part contains mainly metal A but may also contain metal B and/or AB alloys.

Metal B coatings can be applied to metal A particles to form core-shell A/B particles in a variety of ways. Examples include, but are not limited to, redox reaction with a metal B salt, electroplating, and melt processing of melt B nanoparticles.

In some embodiments, a feedstock for 3D printing is a mixture that includes an inert filler configured to decompose at a first temperature; a polymer precursor configured to form a polymeric material, wherein the polymeric material is configured to decompose at a second temperature that is equal to or greater than the first temperature; a photoinitiator configured to initiate formation of the polymeric material from the polymer precursor when exposed to photoradiation having a first wavelength; a photoinhibitor configured to inhibit formation of the polymeric material from the polymer precursor when exposed to photoradiation having a second wavelength; and one or both of 1) core-shell A/B particles and 2) metal A particles and a soluble metal B precursor compound.

A core-shell particle of the present disclosure may comprise of a single material (e.g., a single metal material). In an example, the core and the shell may be comprised of the same metal. Alternatively, the core-shell particle may comprise a plurality of different materials (e.g., a plurality of different metal materials). In some examples, the core may comprise the metal A (e.g., copper) of the present disclosure, and the shell may comprise the metal B (e.g., silver, zinc, indium, lead, magnesium, aluminum, tin) of the present disclosure that is different from the metal A. A thickness of the shell of the core-shell particle may be at least about 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 11%, 12%, 13%, 14%, 15%, 16%, 17%, 18%, 19%, 20%, 30%, 40%, 50%, or more of an average diameter of the core-shell particle. The thickness of the shell of the core-shell particle may be at most about 50%, 40%, 30%, 20%, 19%, 18%, 17%, 16%, 15%, 14%, 13%, 12%, 11%, 10%, 9%, 8%, 7%, 6%, 5%, 4%, 3%, 2%, 1%, 0.9%, 0.8%, 0.7%, 0.6%, 0.5%, 0.4%, 0.3%, 0.2%, 0.1%, or less of the average diameter of the core-shell particle.

The shell of the core-shell particle may cover the entire surface of the core of the core-shell particle. Alternatively, the shell may cover at least about 1%, 2%, 3%, 4%, 5%, 6%, 7%, 8%, 9%, 10%, 15%, 20%, 30%, 40%, 50%, 60%, 70%, 80%, 90%, 99%, or more of the surface of the core. The shell may cover at most about 99%, 90%, 80%, 70%, 60%, 50%, 40%, 30%, 20%, 15%, 10%, 9%, 8%, 7%, 6%, 5%, 4%, 3%, 2%, 1%, or less of the surface of the core.

The shell of the core-shell particle may comprise a single layer. Alternatively, the shell of the core-shell particle may comprise a plurality of layers (i.e., multilayers), e.g., at least 2, 3, 4, 5, 6, 7, 8, 9, 10, or more layers. The plurality of layers may be of the same material (e.g., the same metal material) or different materials (e.g., different metal materials).

The core of the core-shell particle may comprise a first metal, e.g., the metal A as provided in the present disclosure. The shell of the core-shell particle may comprise a second metal, e.g., the metal B as provided in the present disclosure. In an example, the core of the core-shell particle may comprise copper, and the shell of the core-shell particle may comprise one or more members selected from the group consisting of silver, zinc, indium, lead, magnesium, aluminum, and tin. The first metal of the core and the second metal of the shell may be capable of forming an alloy. In some cases, one or more AB alloys may create one or more interface layers between the core and the shell of the core-shell particle. Such formation of the alloy may transform the core-shell particle into a homogeneous alloy particle. Alternatively, the formation of the alloy may transform the core-shell particle into a heterogenous alloy particle comprising a first AB alloy and one or more additional portions selected from the group consisting of (i) a second AB alloy that is structurally different than the first AB alloy, (ii) a second AB alloy that has a different molar ratio between the metal A and the metal B than the first AB alloy, (iii) a metal region that is substantially comprised of the metal A, and (iv) a metal region that is substantially comprised of the metal B.

Prior to subjecting at least a portion of the shell to alloy with at least a portion of the core, the core and the shell may not share a common material (e.g., a common metal material). Alternatively, prior to subjecting at least a portion of the shell to alloy with at least a portion of the core, the core and the shell may share at least one common material (e.g., at least one common metal material).

The temperature at which the polymeric material is configured to decompose may be the same as the temperature at which the inert filter is configured to decompose. Alternatively, the temperature at which the polymeric material is configured to decompose may be greater than the temperature at which the inert filter is configured to decompose by at least about 0.1° C., 0.2° C., 0.3° C., 0.4° C., 0.5° C., 0.6° C., 0.7° C., 0.8° C., 0.9° C., 1° C., 1.5° C., 2° C., 3° C., 4° C., 5° C., 6° C., 7° C., 8° C., 9° C., 10° C., 15° C., 20° C., 25° C., 30° C., 35° C., 40° C., 45° C., 50° C., 60° C., 70° C., 80° C., 90° C., 100° C., 110° C., 120° C., 130° C., 140° C., 150° C., 200° C., or more. The temperature at which the polymeric material is configured to decompose may be greater than the temperature at which the inert filter is configured to decompose by at most about 200° C., 150° C., 140° C., 130° C., 120° C., 110° C., 100° C., 90° C., 80° C., 70° C., 60° C., 50° C., 45° C., 40° C., 35° C., 30° C., 25° C., 20° C., 15° C., 10° C., 9° C., 8° C., 7° C., 6° C., 5° C., 4° C., 3° C., 2° C., 1.5° C., 1° C., 0.9° C., 0.8° C., 0.7° C., 0.6° C., 0.5° C., 0.4° C., 0.3° C., 0.2° C., 0.1° C., or less.

The temperature at which the polymeric material is configured to decompose may be the same as the temperature at which the metallic precursor (e.g., the soluble metallic precursor) is configured to react to form one or more particles. Alternatively, the temperature at which the polymeric material is configured to decompose may be greater than the temperature at which the metallic precursor is configured to react to form the one or more particles by at least about 0.1° C., 0.2° C., 0.3° C., 0.4° C., 0.5° C., 0.6° C., 0.7° C., 0.8° C., 0.9° C., 1° C., 1.5° C., 2° C., 3° C., 4° C., 5° C., 6° C., 7° C., 8° C., 9° C., 10° C., 15° C., 20° C., 25° C., 30° C., 35° C., 40° C., 45° C., 50° C., 60° C., 70° C., 80° C., 90° C., 100° C., 110° C., 120° C., 130° C., 140° C., 150° C., 200° C., or more. The temperature at which the polymeric material is configured to decompose may be greater than the temperature at which the metallic precursor is configured to react to form the one or more particles by at most about 200° C., 150° C., 140° C., 130° C., 120° C., 110° C., 100° C., 90° C., 80° C., 70° C., 60° C., 50° C., 45° C., 40° C., 35° C., 30° C., 25° C., 20° C., 15° C., 10° C., 9° C., 8° C., 7° C., 6° C., 5° C., 4° C., 3° C., 2° C., 1.5° C., 1° C., 0.9° C., 0.8° C., 0.7° C., 0.6° C., 0.5° C., 0.4° C., 0.3° C., 0.2° C., 0.1° C., or less.

Whether using the soluble metal precursor or the core-shell particle, a final 3D object formed subsequent to the sintering process, as disclosed herein, may have a metal B content of at least 0.01%, 0.02%, 0.03%, 0.04%, 0.05%, 0.1%, 0.2%, 0.3%, 0.4%, 0.5%, 1%, 2%, 3%, 4%, 5%, 10%, 11%, 12%, 13%, 14%, 15%, 20%, or more. The final 3D object formed subsequent to the sintering process may have a metal B content of at most 20%, 15%, 14%, 13%, 12%, 11%, 10%, 5%, 4%, 3%, 2%, 1%, 0.5%, 0.4%, 0.3%, 0.2%, 0.1%, 0.05%, 0.04%, 0.03%, 0.02%, 0.01%, or less. The remaining content of the resulting 3D object may be comprised substantially of the metal A.

Whether using the soluble metal precursor or the core-shell particle, a sintered 3D object formed by the methods described herein may be characterized by having a density of the metal A that is higher than a control sintered 3D object formed by methods using a mixture that (i) comprises a plurality of particles of the metal A and (ii) does not comprise the soluble metal precursor of the metal B and/or the core-shell particle. The density of the metal A of the sintered 3D object formed by the methods described herein may be higher than the density of the metal A of the control sintered 3D object by at least 1-fold, 1.5-fold, 2-fold, 3-fold, 4-fold, 5-fold, 6-fold, 7-fold, 8-fold, 9-fold, 10-fold, 11-fold, 12-fold, 13-fold, 14-fold, 15-fold, 16-fold, 17-fold, 18-fold, 19-fold, 20-fold, 25-fold, 30-fold, 35-fold, 40-fold, 45-fold, 50-fold, 60-fold, 70-fold, 80-fold, 90-fold, 100-fold, 150-fold, 200-fold, 300-fold, 400-fold, 500-fold, or more. The density of the metal A of the sintered 3D object formed by the methods described herein may be higher than the density of the metal A of the control sintered 3D object by at most 500-fold, 400-fold, 300-fold, 200-fold, 150-fold, 100-fold, 90-fold, 80-fold, 70-fold, 60-fold, 50-fold, 45-fold, 40-fold, 35-fold, 30-fold, 25-fold, 20-fold, 19-fold, 18-fold, 17-fold, 16-fold, 15-fold, 14-fold, 13-fold, 12-fold, 11-fold, 10-fold, 9-fold, 8-fold, 7-fold, 6-fold, 5-fold, 4-fold, 3-fold, 2-fold, 1.5-fold, 1-fold, or less.

Suitable inert fillers include, but are not limited to, polyethylene waxes, polypropylene, polystyrene, polyalphamethylstyrene, polycarbonate, polyethyleneoxide, polypropyleneoxide, polymethylmethacrylate, or copolymers thereof.

In some embodiments, a 3D object (e.g., a green part) may be printed using any one of the mixtures (or feedstock mixtures) disclosed herein. In some cases, the green part may comprise (i) a first plurality of particles comprising a first metal and (ii) a second plurality of particles comprising a second metal, wherein the first metal and second metal are capable of forming an alloy. The first plurality of particles and the second plurality of particles may not have formed an alloy during printing of the green part. Alternatively, at most about 0.1%, 0.2%, 0.3%, 0.4%, 0.5%, 1%, 1.5%, 2%, 3%, 4%, 5%, 6%, 7%, 8%, 9%, 10%, 15%, 20%, 25%, 30%, 35%, or 40% of the first plurality of particles and the second plurality of particles may have formed an alloy during printing of the green part. The external stimuli (e.g., light, heat, etc.) utilized for printing the green part may not be sufficient to form an alloy from the first plurality of particles and the second plurality of particles. As such, the first plurality of particles and the second plurality of particles may form an alloy during a subsequent treatment (e.g., sintering).

In some embodiments, a 3D object (e.g., a green part) may be printed using any one of the mixtures (or feedstock mixtures) disclosed herein. In some cases, the green part may comprise a plurality of heterogeneous particles. A heterogeneous particle of the plurality may comprise (i) a first portion comprising a first metal and (ii) a second portion comprising a second metal. The first metal of the first portion and the second metal of the second portion may be capable of forming an alloy. The first metal of the first portion and the second metal of the second portion may not have formed an alloy during printing of the green part. Alternatively, at most about 0.1%, 0.2%, 0.3%, 0.4%, 0.5%, 1%, 1.5%, 2%, 3%, 4%, 5%, 6%, 7%, 8%, 9%, 10%, 15%, 20%, 25%, 30%, 35%, or 40% of the first metal of the first portion and the second metal of the second portion may have formed an alloy during printing of the green part. The external stimuli (e.g., light, heat, etc.) utilized for printing the green part may not be sufficient to form an alloy from the first metal and the second metal within the heterogeneous particle. As such, the heterogeneous particle of the plurality may transform into an alloy during a subsequent treatment (e.g., sintering).

### Other Components of the Mixture

The mixture of the present disclosure may further comprise a photoinhibitor. The photoinhibitor may be present in the mixture at an amount from about 0.001 wt.% to about 5 wt.%. The photoinhibitor may be present in the mixture at amount greater than or equal to about 0.001 wt.%, 0.002 wt.%, 0.003 wt.%, 0.004 wt.%, 0.005 wt.%, 0.006 wt.%, 0.007 wt.%, 0.008 wt.%, 0.009 wt.%, 0.01 wt.%, 0.02 wt.%, 0.03 wt.%, 0.04 wt.%, 0.05 wt.%, 0.1 wt.%, 0.5 wt.%, 1 wt.%, 5 wt.%, or more. The photoinhibitor may be present in the mixture at an amount less than or equal to about 5 wt.%, 1 wt.%, 0.5 wt.%, 0.1 wt.%, 0.05 wt.%, 0.04 wt.%, 0.03 wt.%, 0.02 wt.%, 0.01 wt.%, 0.009 wt.%, 0.008 wt.%, 0.007 wt.%, 0.006 wt.%, 0.005 wt.%, 0.004 wt.%, 0.003 wt.%, 0.002 wt.%, 0.001 wt.%, or less.

Some photoactivated radicals can preferentially terminate free radical polymerization, rather than initiating polymerizations, and the species that become such photoactivated radicals upon photoactivation may be used as photoinhibitors. In an example, ketyl radicals may terminate rather than initiate photopolymerizations. Most controlled radical polymerization techniques utilize a radical species that selectively terminates growing radical chains. Examples of such radical species include sulfanylthiocarbonyl and other radicals generated in photoiniferter (photo-initiator, transfer agent, and terminator) mediated polymerizations; sulfanylthiocarbonyl radicals used in reversible addition-fragmentation chain transfer polymerization; and nitrosyl radicals used in nitroxide mediate polymerization. In addition, lophyl radicals may be non-reactive towards the polymerization of acrylates in the absence of strong chain transfer agents. Other non-radical species that may be generated to terminate growing radical chains may include the numerous metal/ligand complexes used as deactivators in atom-transfer radical polymerization (ATRP). Non-limiting examples of the photoinhibitor include thiocarbamates, xanthates, dithiobenzoates, photoinitiators that generate ketyl and other radicals that tend to terminate growing polymer chains radicals (i.e., camphorquinone and benzophenones), ATRP deactivators, and polymeric versions thereof.

In some cases, the photoinhibitor may comprise a hexaarylbiimidazole (HABI) or a functional variant thereof. In some cases, the hexaarylbiimidazole may comprise a phenyl group with a halogen and/or an alkoxy substitution. In an example, the phenyl group comprises an ortho-chloro-substitution. In another example, the phenyl group comprises an ortho-methoxy-substitution. In another example, the phenyl group comprises an ortho-ethoxy-substitution. Examples of the functional variants of the hexaarylbiimidazole include: 2,2′-Bis(2-chlorophenyl)-4,4',5,5′-tetraphenyl-1,2′-biimidazole; 2-(2-methoxyphenyl)-1-[2-(2-methoxyphenyl)-4,5-diphenyl-2H-imidazol-2-yl]-4,5-diphenyl-1H-imidazole; 2-(2-ethoxyphenyl)-1-[2-(2-ethoxyphenyl)-4,5-diphenyl-2H-imidazol-2-yl]-4,5-diphenyl-1H-imidazole; and 2,2',4-tris-(2-Chlorophenyl)-5-(3,4-dimethoxyphenyl)-4',5′-diphenyl-1,1′-biimidazole.

Other examples of the photoinhibitor in the mixture include one or more of: zinc dimethyl dithiocarbamate: zinc dimethyl dithiocarbamate; zinc diethyl dithiocarbamate; zinc dibutyl dithiocarbamate; nickel dibutyl dithiocarbamate; zinc dibenzyl dithiocarbamate; tetramethylthiuram disulfide; tetraethylthiuram disulfide (TEDS); tetramethylthiuram monosulfide; tetrabenzylthiuram disulfide; tetraisobutylthiuram disulfide; dipentamethylene thiuram hexasulfide; N,N′-dimethyl N,N′-di(4-pyridinyl)thiuram disulfide; 3-Butenyl 2-(dodecylthiocarbonothioylthio)-2-methylpropionate; 4-Cyano-4-[(dodecylsulfanylthiocarbonyl)sulfanyl]pentanoic acid; 4-Cyano-4-[(dodecylsulfanylthiocarbonyl)sulfanyl]pentanol; Cyanomethyl dodecyl trithiocarbonate; Cyanomethyl [3-(trimethoxysilyl)propyl] trithiocarbonate; 2-Cyano-2-propyl dodecyl trithiocarbonate; S,S-Dibenzyl trithiocarbonate; 2-(Dodecylthiocarbonothioylthio)-2-methylpropionic acid; 2-(Dodecylthiocarbonothioylthio)-2-methylpropionic acid N-hydroxysuccinimide; Benzyl 1H-pyrrole-1-carbodithioate; Cyanomethyl diphenylcarbamodithioate; Cyanomethyl methyl(phenyl)carbamodithioate; Cyanomethyl methyl(4-pyridyl)carbamodithioate; 2-Cyanopropan-2-yl N-methyl-N-(pyridin-4-yl)carbamodithioate; Methyl 2-[methyl(4-pyridinyl)carbamothioylthio]propionate; 1-Succinimidyl-4-cyano-4-[N-methyl-N-(4-pyridyl)carbamothioylthio]pentanoate; Benzyl benzodithioate; Cyanomethyl benzodithioate; 4-Cyano-4-(phenylcarbonothioylthio)pentanoic acid; 4-Cyano-4-(phenylcarbonothioylthio)pentanoic acid N-succinimidyl ester; 2-Cyano-2-propyl benzodithioate; 2-Cyano-2-propyl 4-cyanobenzodithioate; Ethyl 2-(4-methoxyphenylcarbonothioylthio)acetate; 2-Phenyl-2-propyl benzodithioate; Cyanomethyl methyl(4-pyridyl)carbamodithioate; 2-Cyanopropan-2-yl N-methyl-N-(pyridin-4-yl)carbamodithioate; Methyl 2-[methyl(4-pyridinyl)carbamothioylthio]propionate; 1,1′-Bi-1H-imidazole; and functional variants thereof.

For photoinhibition to occur during the 3D printing, the amount of the photoinhibitor in the mixture may be sufficient to generate inhibiting radicals at a greater rate that initiating radicals are generated. The ratio of the amount of the photoinhibitor and/or the photoinitiator may be modified based on the intensity of the optical sources available, and/or the quantum yields and light absorption properties of the photoinhibitor and the photoinitiator in the mixture.

The mixture of the present disclosure may further comprise a photoinitiator. A photoinitiator may be present in the mixture at an amount from about 0.001 wt.% to about 5 wt.%. The photoinitiator may be present in the mixture at an amount greater than or equal to about 0.001 wt.%, 0.002 wt.%, 0.003 wt.%, 0.004 wt.%, 0.005 wt.%, 0.006 wt.%, 0.007 wt.%, 0.008 wt.%, 0.009 wt.%, 0.01 wt.%, 0.02 wt.%, 0.03 wt.%, 0.04 wt.%, 0.05 wt.%, 0.1 wt.%, 0.5 wt.%, 1 wt.%, 5 wt.%, or more. The photoinitiator may be present in the mixture at an amount less than or equal to about 5 wt.%, 1 wt.%, 0.5 wt.%, 0.1 wt.%, 0.05 wt.%, 0.04 wt.%, 0.03 wt.%, 0.02 wt.%, 0.01 wt.%, 0.009 wt.%, 0.008 wt.%, 0.007 wt.%, 0.006 wt.%, 0.005 wt.%, 0.004 wt.%, 0.003 wt.%, 0.002 wt.%, 0.001 wt.%, or less.

The photoinitiator may be selected to absorb little (e.g., less than or equal to about 10%, 5%, 4%, 3%, 2%, 1%, 0.1%, or less) or no light at the one or more wavelengths used to activate the photoinhibitor. In some cases, some overlap of the light absorption spectra of the photoinitiator and the photoinhibitor may be tolerated depending on the relative reaction rates (e.g., the figure of merit described above). Suitable photoinitiators include one or more of benzophenones, thioxanthones, anthraquinones, benzoylformate esters, hydroxyacetophenones, alkylaminoacetophenones, benzil ketals, dialkoxyacetophenones, benzoin ethers, phosphine oxides, acyloximino esters, alphahaloacetophenones, trichloromethyl-S-triazines, titanocenes, dibenzylidene ketones, ketocoumarins, dye sensitized photoinitiation systems, maleimides, and functional variants thereof. In some cases, the photoinitiator may comprise camphorquinone (CQ) and/or a functional variant thereof.

Example families of useful photoinitiators include: hydroxyacetophenones, alkylaminoacetonphenones, benzil ketals, dialkoxyacetophenones, benzoin ethers, phosphine oxides, acyloximino esters, alphahaloacetophenones, benzophenones, thioxanthones, anthraquinones, camphorquinones, ketocoumarins, and curcumin derivatives. Examples of the photoinitiator in the mixture include one or more of: 1-hydroxy-cyclohexyl-phenyl-ketone (Irgacure™ 184; BASF, Hawthorne, NJ); a 1:1 mixture of 1-hydroxy-cyclohexyl-phenyl-ketone and benzophenone (Irgacure™ 500; BASF); 2-hydroxy-2-methyl-1-phenyl-1-propanone (Darocur™ 1173; BASF); 2-hydroxy-1-[4-(2-hydroxyethoxy)phenyl]-2-methyl-1-propanone (Irgacure™ 2959; BASF); methyl benzoylformate (Darocur™ MBF; BASF); oxy-phenyl-acetic acid 2-[2-oxo-2-phenyl-acetoxy-ethoxy]-ethyl ester; oxy-phenyl-acetic 2-[2-hydroxy-ethoxy]-ethyl ester; a mixture of oxy-phenyl-acetic acid 2-[2-oxo-2-phenyl-acetoxy-ethoxy]-ethyl ester and oxy-phenyl-acetic 2-[2-hydroxy-ethoxy]-ethyl ester (Irgacure™ 754; BASF); alpha,alpha-dimethoxy-alpha-phenylacetophenone (Irgacure™ 651; BASF); 2-benzyl-2-(dimethylamino)-1-[4-(4-morpholinyl)-phenyl]-1-butanone (Irgacure™ 369; BASF); 2-methyl-1-[4-(methylthio)phenyl]-2-(4-morpholinyl)-1-propanone (Irgacure™ 907; BASF); a 3:7 mixture of 2-benzyl-2-(dimethylamino)-1-[4-(4-morpholinyl) phenyl]-1-butanone and alpha,alpha-dimethoxy-alpha-phenylacetophenone per weight (Irgacure™ 1300; BASF); diphenyl-(2,4,6-trimethylbenzoyl) phosphine oxide (Darocur™ TPO; BASF); a 1:1 mixture of diphenyl-(2,4,6-trimethylbenzoyl)-phosphine oxide and 2-hydroxy-2-methyl-1-phenyl-1-propanone (Darocur™ 4265; BASF); phenyl bis(2,4,6-trimethyl benzoyl) phosphine oxide, which may be used in pure form (Irgacure™ 819; BASF, Hawthorne, NJ) or dispersed in water (45% active, Irgacure™ 819DW; BASF); 2:8 mixture of phosphine oxide, phenyl bis(2,4,6-trimethyl benzoyl) and 2-hydroxy-2-methyl-1-phenyl-1-propanone (Irgacure™ 2022; BASF); Irgacure™ 2100, which comprises phenyl-bis(2,4,6-trimethylbenzoyl)-phosphine oxide); bis-(eta 5-2,4-cyclopentadien-1-yl)-bis-[2,6-difluoro-3-(1H-pyrrol-1-yl) phenyl]-titanium (Irgacure™ 784; BASF); (4-methylphenyl) [4-(2-methylpropyl) phenyl]- iodonium hexafluorophosphate (Irgacure™ 250; BASF); 2-(4-methylbenzyl)-2-(dimethylamino)-1-(4-morpholinophenyl)-butan-1-one (Irgacure™ 379; BASF); 4-(2-hydroxyethoxy)phenyl-(2-hydroxy-2-propyl)ketone (Irgacure™ 2959; BASF); bis-(2,6-dimethoxybenzoyl)-2,4,4-trimethylpentylphosphine oxide ; a mixture of bis-(2,6-dimethoxybenzoyl)-2,4,4-trimethylpentylphosphine oxide and 2 hydroxy-2-methyl-1-phenyl-propanone (Irgacure™ 1700; BASF); 4-Isopropyl-9-thioxanthenone; Bis[4-(dimethylamino)phenyl]methanone; Bis[4-(diethylamino)phenyl]methanone; and functional variants thereof.

The mixture of the present disclosure may further comprise a stabilizer. The stabilizer may be configured to inhibit formation of the polymeric material from at least a portion of the polymeric precursor. The stabilizer may be present in the mixture at an amount from about 0.0001 wt.% to about 0.5 wt.%. The stabilizer may be present in the mixture at an amount greater than or equal to about 0.0001 wt.%, 0.0002 wt.%, 0.0003 wt.%, 0.0004 wt.%, 0.0005 wt.%, 0.0006 wt.%, 0.0007 wt.%, 0.0008 wt.%, 0.0009 wt.%, 0.001 wt.%, 0.002 wt.%, 0.003 wt.%, 0.004 wt.%, 0.005 wt.%, 0.01 wt.%, 0.05 wt.%, 0.1 wt.%, 0.5 wt.%, or more. The stabilizer may be present in the mixture at an amount less than or equal to about 0.5 wt.%, 0.1 wt.%, 0.05 wt.%, 0.01 wt.%, 0.005 wt.%, 0.004 wt.%, 0.003 wt.%, 0.002 wt.%, 0.001 wt.%, 0.0009 wt.%, 0.0008 wt.%, 0.0007 wt.%, 0.0006 wt.%, 0.0005 wt.%, 0.0004 wt.%, 0.0003 wt.%, 0.0002 wt.%, 0.0001 wt.%, or less.

The presence of the stabilizer in the mixture may increase the critical energy of the light for the mixture. In some cases, the stabilizer may be a radical inhibitor. Examples of the radical inhibitor include a quinone, hydroquinoe, nitrosamine, copper-comprising compound, stable free radical (e.g., (2,2,6,6-tetramethylpiperidin-1-yl)oxidanyl), substituted phenol, mequinol, t-butyl catechol, Nitorosophenylhydroxylamine alminium salt, functional variants thereof, or mixtures thereof. In some examples, the radical inhibitor may comprise phenothiazine, copper napthalate, butylated hydroxytoluene, or functional variants thereof. The radical inhibitor may be added to the polymeric precursor (e.g., acrylate monomers) as stabilizers to prevent premature curing (e.g., polymerization, cross-linking) during handling prior to 3D printing. In some cases, in at least a portion of the mixture that is exposed to the second light (photoinhibition light), formation of the polymeric material from the polymeric precursors may not begin until most if not all of the photoinhibitors are activated and consumed (e.g., by initiating radicals) in the at least the portion of the mixture. Depending on steric, electronic, and/or mechanistic properties of the stabilizer (e.g., the radical inhibitor), the effect of the stabilizer on the critical energy of the photoinitiation light or the photoinhibition light may be different. In some cases, the addition of the stabilizer to the mixture may disproportionally increase the critical energy of the photoinhibition light for the mixture relative to the critical energy of the photoinitiation light for the mixture. In some cases, the addition of the stabilizer to the mixture may disproportionally increase the critical energy of the photoinitiation light for the mixture relative to the critical energy of the photoinhibition light for the mixture.

The mixture of the present disclosure may further comprise a co-initiator. A co-initiator may be configured to initiate formation of the polymeric material from the polymeric precursor. In some cases, the co-initiator is present in the mixture at an amount from about 0.01 wt.% to about 10 wt.%. The co-initiator may be present in the mixture at an amount greater than or equal to about 0.01 wt.%, 0.02 wt.%, 0.03 wt.%, 0.04 wt.%, 0.05 wt.%, 0.06 wt.%, 0.07 wt.%, 0.08 wt.%, 0.09 wt.%, 0.1 wt.%, 0.2 wt.%, 0.3 wt.%, 0.4 wt.%, 0.5 wt.%, 1 wt.%, 2 wt.%, 3 wt.% , 4 wt.%, 5 wt.%, 6 wt.%, 7 wt.%, 8 wt.%, 9 wt.%, 10 wt.%, or more. The co-initiator may be present in the mixture at an amount less than or equal to about 10 wt.%, 9 wt.%, 8 wt.%, 7 wt.%, 6 wt.%, 5 wt.%, 4 wt.%, 3 wt.%, 2 wt.%, 1 wt.%, 0.5 wt.%, 0.4 wt.%, 0.3 wt.%, 0.2 wt.%, 0.1 wt.%, 0.09 wt.%, 0.08 wt.%, 0.07 wt.%, 0.06 wt.%, 0.05 wt.%, 0.04 wt.%, 0.03 wt.%, 0.02 wt.%, 0.01 wt.%, or less. In other instances, the co-initiator configured to initiate formation of the polymeric material comprises one or more functional groups that act as a co-initiator. The one or more functional groups may be diluted by being attached to a larger molecule. In such cases, the co-initiator may be present in the mixture at an amount greater than or equal to about 0.01 wt.%, 0.02 wt.%, 0.03 wt.%, 0.04 wt.%, 0.05 wt.%, 0.06 wt.%, 0.07 wt.%, 0.08 wt.%, 0.09 wt.%, 0.1 wt.%, 0.2 wt.%, 0.3 wt.%, 0.4 wt.%, 0.5 wt.%, 1 wt. %, 2 wt.%, 3 wt.% , 4 wt.%, 5 wt.%, 6 wt.%, 7 wt.%, 8 wt.%, 9 wt.%, 10 wt.%, 11 wt.%, 12 wt.%, 13 wt.%, 14 wt.%, 15 wt.%, 16 wt.%, 17 wt.%, 18 wt.%, 19 wt.%, 20 wt.%, 21 wt.%, 22 wt.%, 23 wt.%, 24 wt.%, 25 wt.%, or more. The co-initiator may be present in the mixture at an amount less than or equal to about 25 wt.%, 24 wt.%, 23 wt.%, 22 wt.%, 21 wt.%, 20 wt.%, 19 wt.%, 18 wt.%, 17 wt.%, 16 wt.%, 15 wt.%, 14 wt.%, 13 wt.%, 12 wt.%, 11 wt.%, 10 wt.% , 9 wt.%, 8 wt.%, 7 wt.%, 6 wt.%, 5 wt.%, 4 wt.%, 3 wt.%, 2 wt.%, 1 wt.%, 0.5 wt.%, 0.4 wt.%, 0.3 wt.%, 0.2 wt.%, 0.1 wt.%, 0.09 wt.%, 0.08 wt.%, 0.07 wt.%, 0.06 wt.%, 0.05 wt.%, 0.04 wt.%, 0.03 wt.%, 0.02 wt.%, 0.01 wt.%, or less.

The co-initiator in the mixture may enhance the rate of formation of the polymeric material from the polymeric precursor. The co-initiator may comprise primary, secondary, and tertiary amines, alcohols, and thiols. In some cases, the co-initiator may comprise a tertiary amine. In some cases, the co-initiator may comprise ethyl-dimethyl-amino benzoate (EDMAB) or a functional variant thereof. Additional examples of the co-initiator include one or more of: isoamyl 4-(dimethylamino)benzoate, 2-ethylhexyl 4-(dimethylamino)benzoate; ethyl 4-(dimethylamino)benzoate; 3-(dimethylamino)propyl acrylate; 2-(dimethylamino)ethyl methacrylate; 4-(dimethylamino)benzophenones, 4-(diethylamino)benzophenones; 4,4′-Bis(diethylamino)benzophenones; methyl diethanolamine; triethylamine; hexane thiol; heptane thiol; octane thiol; nonane thiol; decane thiol; undecane thiol; dodecane thiol; isooctyl 3-mercaptopropionate; pentaerythritol tetrakis(3-mercaptopropionate); 4,4′-thiobisbenzenethiol; trimethylolpropane tris(3-mercaptopropionate); CN374 (Sartomer); CN371 (Sartomer), CN373 (Sartomer), Genomer 5142 (Rahn); Genomer 5161 (Rahn); Genomer(5271 (Rahn); Genomer 5275 (Rahn), TEMPIC (Bruno Boc, Germany), and functional variants thereof. Alternatively or in addition to, performance of a photoinitiator can also be improved through the addition of a sensitizing dye. Examples of the sensitizing dye may include, but are not limited to, eosin, cyanine, acridinium, flavine, xanthene, thiazine based dyes, functional variants thereof, and combinations thereof.

The mixture of the present disclosure may further comprise a light absorber. The light may be configured to absorb at least the first wavelength of the first light or the second wavelength of the second light. In some cases, the light absorber is present in the mixture at an amount from about 0.001 wt.% to about 5 wt.%. The light absorber may be present in the mixture at amount greater than or equal to about 0.001 wt.%, 0.002 wt.%, 0.003 wt.%, 0.004 wt.%, 0.005 wt.%, 0.006 wt.%, 0.007 wt.%, 0.008 wt.%, 0.009 wt.%, 0.01 wt.%, 0.02 wt.%, 0.03 wt.%, 0.04 wt.%, 0.05 wt.%, 0.1 wt.%, 0.5 wt.%, 1 wt.%, 5 wt.%, or more. The light absorber may be present in the mixture at an amount less than or equal to about 5 wt.%, 1 wt.%, 0.5 wt.%, 0.1 wt.%, 0.05 wt.%, 0.04 wt.%, 0.03 wt.%, 0.02 wt.%, 0.01 wt.%, 0.009 wt.%, 0.008 wt.%, 0.007 wt.%, 0.006 wt.%, 0.005 wt.%, 0.004 wt.%, 0.003 wt.%, 0.002 wt.%, 0.001 wt.%, or less.

In some cases, the light absorber may be a dye or pigment. The light absorber can be used to both attenuate light and to transfer energy (e.g., via Förster resonance energy transfer (FRET)) to photoactive species (e.g., the photoinitiator or the photoinhibitor), thereby to increase the sensitivity of the resulting mixture to a given wavelength suitable for the photoinitiation and/or the photoinhibition process. A concentration of the light absorber may be highly dependent on the light absorption properties of the light absorber, as well as the optical attenuation from other components in the mixtures. In an example, the light absorber may be configured to absorb at the second wavelength, and exposing the mixture to the second light having the second wavelength may initiate the light absorber to reduce an amount of the second light exposed to at least a portion of the mixture. One or more light absorbers may be combined at a plurality of concentrations to restrict the penetration of the photoinhibition light to a given thickness such that the photoinhibition layer is thick enough to permit separation of the newly formed layer of the 3D object from the print surface (e.g., the window). The one or more light absorbers may be combined at the plurality of concentrations to restrict penetration and/or propagation of the photoinitiating light during printing at least a portion of the 3D object. In some cases, a plurality of light absorbers may be used to independently control both photoinhibition and photoinitiation processes.

Examples of the light absorber include compounds commonly used as UV absorbers for decreasing weathering of coatings, such as: 2-hydroxyphenyl-benzophenones; 2-(2-hydroxyphenyl)-benzotriazoles(and chlorinated derivatives); and 2-hydroxyphenyl-s-triazines. Additional examples of the light absorber include those used for histological staining or dying of fabrics. Pigments such as carbon black, pthalocyanine, toluidine red, quinacridone, titanium dioxide, and functional variants thereof may also be used as light absorbers in the mixture. Dyes that may be used as light absorbers include: Martius yellow; quinolone yellow; Sudan red, Sudan I, Sudan IV, eosin, eosin Y, neutral red, acid red, Sun Chemical UVDS 150; Sun Chemical UVDS 350; Penn Color Cyan; Sun Chemical UVDJ107; 2-tert-Butyl-6-(5-chloro-2H-benzotriazol-2-yl)-4-methylphenol; 2-(2H-Benzotriazol-2-yl)-4,6-di-tert-pentylphenol; 7-diethylamino-4-methyl coumarin; 9,10-Dibutoxyanthracene; 9-phenyl acridine; and functional variants thereof.

A polymeric precursor of the mixture of the present disclosure may comprise monomers, one or more oligomers, or both. The monomers may be configured to polymerize to form the polymeric material. The one or more oligomers may be configured to cross-link to form the polymeric material. The monomers may be of the same or different types. An oligomer may comprise two or more monomers that are covalently linked to each other. The oligomer may be of any length, such as greater than or equal to about 2 (dimer), 3 (trimer), 4 (tetramer), 5 (pentamer), 6 (hexamer), 7, 8, 9, 10, 20, 30, 40, 50, 100, 200, 300, 400, 500, or more monomers. As an alternative, the oligomer may be of a length less than or equal to about 500, 400, 300, 200, 100, 50, 40, 30, 20, 10, 9, 8, 7, 6, 5, 4, 3, 2, or less monomers. Alternatively or in addition to, the polymeric precursor may include a dendritic precursor (monodisperse or polydisperse). The dendritic precursor may be a first generation (G1), second generation (G2), third generation (G3), fourth generation (G4), or higher with functional groups remaining on the surface of the dendritic precursor. The resulting polymeric material may comprise a monopolymer and/or a copolymer. The copolymer may be a linear copolymer or a branched copolymer. The copolymer may be an alternating copolymer, periodic copolymer, statistical copolymer, random copolymer, and/or block copolymer. In some cases, the polymeric precursor (e.g., monomer, oligomer, or both) may comprise one or more acrylates.

In some cases, the monomers is present in the mixture at an amount from about 1 wt.% to about 80 wt.%. The monomers may be present in the mixture at an amount greater than or equal to about 1 wt.%, 2 wt.%, 3 wt.%, 4 wt.%, 5 wt.%, 6 wt.%, 7 wt.%, 8 wt.%, 9 wt.%, 10 wt.%, 15 wt.%, 20 wt.%, 25 wt.%, 30 wt.%, 35 wt.%, 40 wt.%, 45 wt.%, 50 wt.%, 55 wt.%, 60 wt.%, 65 wt.%, 70 wt.%, 75 wt.%, 80 wt.%, or more. The monomers may be present in the mixture at an amount less than or equal to about 80 wt.%, 75 wt.%, 70 wt.%, 65 wt.%, 60 wt.%, 55 wt.%, 50 wt.%, 45 wt.%, 40 wt.%, 35 wt.%, 30 wt.%, 25 wt.%, 20 wt.%, 15 wt.%, 10 wt.%, 9 wt.%, 8 wt.%, 7 wt.%, 6 wt.%, 5 wt.%, 4 wt.%, 3 wt.%, 2 wt.%, 1 wt.%, or less. In some cases, the mixture may not have any monomers. In such a scenario, the mixture may have one or more oligomers.

Examples of monomers include one or more of hydroxyethyl methacrylate; n-Lauryl acrylate; tetrahydrofurfuryl methacrylate; 2 , 2, 2 - trifluoroethyl methacrylate; isobornyl methacrylate; polypropylene glycol monomethacrylates, aliphatic urethane acrylate (i.e., Rahn Genomer 1122); hydroxyethyl acrylate; n-Lauryl methacrylate; tetrahydrofurfuryl acrylate; 2 , 2, 2 - trifluoroethyl acrylate; isobornyl acrylate; polypropylene glycol monoacrylates; trimethylpropane triacrylate; trimethylpropane trimethacrylate; pentaerythritol triacrylate; pentaerythritol tetraacrylate; ethoxylated pentaerythritol tetraacrylate; ethoxylated pentaerythritol triacrylate; dipentaerythritol pentacrylate; dipentaerythritol hexacrylate; triethyleneglycol diacrylate; triethylene glycol dimethacrylate; tetrathyleneglycol diacrylate; tetrathylene glycol dimethacrylate; neopentyldimethacrylate; neopentylacrylate; hexane diol dimethacylate; hexane diol diacrylate; polyethylene glycol 400 dimethacrylate; polyethylene glycol 400 diacrylate; diethylglycol diacrylate; diethylene glycol dimethacrylate; ethyleneglycol diacrylate; ethylene glycol dimethacrylate; ethoxylated bis phenol A dimethacrylate; ethoxylated bis phenol A diacrylate; bisphenol A glycidyl methacrylate; bisphenol A glycidyl acrylate; ditrimethylolpropane tetraacrylate; and functional variants thereof. In some cases, the monomers may comprise (i) tricyclodecanediol diacrylate, tricyclodecanediol dimethacrylate, or a functional variant thereof, (ii) tris(2-hydroxy ethyl) isocyanurate triacrylate or a functional variant thereof, or (iii) phenoxy ethyl acrylate or a functional variant thereof. In some cases, one or more monomers provided in the present disclosure may be ethoxylated. In some cases, the one or more monomers may be ethoxylated and then functionalized to generate one or more functional variants, e.g., ethoxylated(4) pentaerythritol acrylate.

In some cases, the one or more oligomers is present in the mixture at an amount from about 1 wt.% to about 30 wt.%. The one or more oligomers may be present in the mixture at an amount greater than or equal to about 1 wt.%, 2 wt.%, 3 wt.%, 4 wt.%, 5 wt.%, 6 wt.%, 7 wt.%, 8 wt.%, 9 wt.%, 10 wt.%, 15 wt.%, 20 wt.%, 25 wt.%, 30 wt.%, or more. The one or more oligomers may be present in the mixture at an amount less than or equal to about 30 wt.%, 25 wt.%, 20 wt.%, 15 wt.%, 10 wt.%, 9 wt.%, 8 wt.%, 7 wt.%, 6 wt.%, 5 wt.%, 4 wt.%, 3 wt.%, 2 wt.%, 1 wt.%, or less. In some cases, the mixture may not have the one or more oligomers. In such a scenario, the mixture may have the monomers.

In some cases, the one or more oligomers may include one or more of: polyether; polyol; epoxy; thioether; polyester; urethane; silicon; polybutadiene; phenolic based acrylates; methacrylates; and functional variants thereof. In some cases, the one or more oligomers may comprise one or more (meth)acrylate monomers from: urethane (meth)acrylate, polyester urethane (meth)acrylate, epoxy(meth)acrylate, polyether (meth)acrylate, polyol (meth)acrylate, dendritic (meth)acrylate, silicone (meth)acrylate, polybutadiene (meth)acrylate, phenolic (meth)acrylate, or a functional variant thereof. Additional examples of the one or more oligomers include Esstech Exothane 126, Esstech Exothane 108, and Sartomer CN9009.

In some embodiments of any of the mixtures disclosed herein, polymeric precursors of the mixture may include acrylates, methacrylates, epoxides, lactones, styrenics, and acrylamides. Polymers formed from such polymeric precursors include, but are not limited to, polyacrylates, polymethacrylates, polyethers, polylactones, polystyrenes, or polyacrylamides.

In some embodiments of any of the mixtures disclosed herein, photoinhibitors of the mixture may include thiocarbamates, xanthates, dithiobenzoates, hexaarylbiimidazoles, photoinititators that generate ketyl and other radicals that tend to terminate growing polymer chains radicals (i.e., camphorquinone and benzophenones), ATRP deactivators, or polymeric versions thereof.

In some embodiments of any of the mixtures disclosed herein, the mixture may comprise inert fillers. Suitable inert fillers include, but are not limited to, polyethylene waxes, polypropylene, polystyrene, polyalphamethylstyrene, polycarbonate, polyethyleneoxide, polypropyleneoxide, or copolymers thereof.

A ratio of the monomers and the one or more oligomers in the polymeric precursor of the mixture may be based on one or more properties of the mixture (e.g., viscosity, curing rate, etc.) that is optimal for each particular 3D printing method. In an example, in the absence of inorganic particles (e.g., metal or ceramic particles) in the mixture, the ratio of the monomer and the one or more oligomers may be optimized to yield a viscosity below 3000 centipoise (cP). In some cases, the viscosity of the mixture may be below 300 cP. In some cases, the viscosity of the mixture is less than or equal to about 3000 cP, 2900 cP, 2800 cP, 2700 cP, 2600 cP, 2500 cP, 2400 cP, 2300 cP, 2200 cP, 2100 cP, 2000 cP, 1500 cP, 1000 cP, 500 cP, 100 cP, or less. As an alternative, the viscosity of the mixture may be greater than or equal to about 100 cP, 500 cP, 1000 cP, 1500 cP, 2000 cP, 2100 cP, 2200 cP, 2300 cP, 2400 cP, 2500 cP, 2600 cP, 2700 cP, 2800 cP, 2900 cP, 3000 cP, or more.

When the mixture comprises one or more particles as disclosed herein, the mixture may have a viscosity ranging from about 4,000 cP to about 2,000 ,000 cP. When the mixture comprises the one or more particles, the mixture may have a viscosity greater than or equal to about 4,000 cP, 10,000 cP, 20,000 cP, 30,000 cP, 40,000 cP, 50,000 cP, 60,000 cP, 70,000 cP, 80,000 cP, 90,000 cP, 100,000 cP, 200,000 cP, 300,000 cP, 400,000 cP, 500,000 cP, 600,000 cP, 700,000 cP, 800,000 cP, 900,000 cP, 1,000 ,000 cP, 2,000 ,000 cP, or more. When the mixture comprises the one or more particles, the mixture may have a viscosity less than or equal to about 2,000 ,000 cP, 1,000 ,000 cP, 900,000 cP, 800,000 cP, 700,000 cP, 600,000 cP, 500,000 cP, 400,000 cP, 300,000 cP, 200,000 cP, 100,000 cP, 90,000 cP, 80,000 cP, 70,000 cP, 60,000 cP, 50,000 cP, 40,000 cP, 30,000 cP, 20,000 cP, 10,000 cP, 4,000 cP, or less.

### Debinding and Sintering

Any of the methods disclosed herein may comprise subjecting a printed 3D object (e.g., a green body) to heating (e.g., in a furnace) to, for example, heat a plurality of particles in the mixture. In some embodiments, the plurality of particles may be pre-formed (e.g., heterogeneous particles, such as core-shell particles, or homogeneous particles). Alternatively or in addition to, the plurality of particles may comprise nanoparticles formed from reaction of a plurality of precursor compounds. The heating may be under conditions sufficient to sinter the plurality of particles to form a final product that is at least a portion of a 3D object or an entire 3D object. During heating (e.g., sintering), the organic components (e.g., the polymeric material, additives, etc.) may decompose and leave the green body. At least a portion of the decomposed organic components may leave the green body in gas phase.

The green body may be heated in a processing chamber. The temperature of the processing temperature may be regulated with at least one heater. The processing chamber may be an oven or a furnace. The oven or furnace may be heated with various heating approaches, such as resistive heating, convective heating and/or radiative heating. Examples of the furnace include an induction furnace, electric arc furnace, gas-fired furnace, plasma arc furnace, microwave furnace, and electric resistance furnace. Such heating may be employed at a fixed or variating heating rate from an initial temperature to a target temperature or temperature range.

A green body comprising metallic and/or intermetallic particles may be heated from room temperature to a processing temperature. The processing temperature may be kept constant or substantially constant for a given period of time, or may be adjusted to one or more other temperatures. The processing temperature may be selected based on the material of the particles in the green body (e.g., the processing temperature may be higher for material having a higher melting point than other materials). The processing temperature may be sufficient to sinter but not completely melt the particles in the green body. As an alternative, the processing temperature may be sufficient to melt the particles in the green body.

The processing temperature for heating (e.g., sintering) the green body (including the metal and/or intermetallic particles) may range between about 300° C. to about 2200° C. The processing temperature for sintering the green body may be at least about 300° C., 350° C., 400° C., 450° C., 500° C., 550° C., 600° C., 650° C., 700° C., 750° C., 800° C., 850° C., 900° C., 950° C., 1000° C., 1050° C., 1100° C., 1150° C., 1200° C., 1250° C., 1300° C., 1350° C., 1400° C., 1450° C., 1500° C., 1550° C., 1600° C., 1700° C., 1800° C., 1900° C., 2000° C., 2100° C., 2200° C., or more. The processing temperature for sintering the green body (including the particles) may be at most about 2200° C., 2100° C., 2000° C., 1900° C., 1800° C., 1700° C., 1600° C., 1550° C., 1500° C., 1450° C., 1400° C., 1350° C., 1300° C., 1250° C., 1200° C., 1150° C., 1100° C., 1050° C., 1000° C., 950° C., 900° C., 850° C., 800° C., 750° C., 700° C., 650° C., 600° C., 550° C., 500° C., 450° C., 400° C., 350° C., 300° C., or less.

In an example, a green body comprising aluminum particles may be heated from room temperature to a processing temperature ranging between about 350° C. to about 700° C. In another example, a green body comprising copper particles may be heated from room temperature to a processing temperature of about 1000° C. In another example, a green body comprising stainless steel particles may be heated from room temperature to a processing temperature ranging between about 1200° C. to about 1500° C. In another example, a green body comprising other tool steel particles may be heated from room temperature to a processing temperature of about 1250° C. In another example, a green body comprising tungsten heavy alloy particles may be heated from room temperature to a processing temperature of about 1500° C.

During sintering the green body comprising the metallic and/or intermetallic particles, the temperature of the processing chamber may change at a rate ranging between about 0.1° C. per minute (degrees Celsius/min) to about 200° C./min. The temperature of the processing chamber may change at a rate of at least about 0.1° C./min, 0.2° C./min, 0.3° C./min, 0.4° C./min, 0.5° C./min, 1° C./min, 2° C./min, 3° C./min, 4° C./min, 5° C./min, 6° C./min, 7° C./min, 8° C./min, 9° C./min, 10° C./min, 20° C./min, 50° C./min, 100° C./min, 150° C./min, 200° C./min, or more. The temperature of the processing chamber may change at a rate of at most about 200° C./min, 150° C./min, 100° C./min, 50° C./min, 20° C./min, 10° C./min, 9° C./min, 8° C./min, 7° C./min, 6° C./min, 5° C./min, 4° C./min, 3° C./min, 2° C./min, 1° C./min, 0.5° C./min, 0.4° C./min, 0.3° C./min, 0.2° C./min, 0.1° C./min, or less.

In some cases, during sintering the green body comprising the metallic and/or intermetallic particles, the process may comprise holding at a fixed temperature between room temperature and the processing temperature for a time ranging between about 1 min to about 240 min. The sintering process may comprise holding at a fixed temperature for at least about 10 min, 20 min, 30 min, 40 min, 50 min, 60 min, 90 min, 120 min, 150 min, 180 min, 210 min, 240 min, or more. The sintering process may comprise holding at a fixed temperature for at most about 240 min, 210 min, 180 min, 150 min, 120 min, 90 min, 60 min, 50 min, 40 min, 30 min, 20 min, 10 min, 1 min, or less. In some cases, during the sintering process, the temperature may not be held at a processing temperature for an extended period of time (e.g., once a target temperature is reached, the temperature may be reduced). In an example, the sintering process may increase the temperature to a first temperature and immediately (e.g., without holding at the first temperature for a period of time) lower the temperature to a second temperature that is lower than the first temperature.

A green body comprising ceramic particles may be heated from room temperature to a processing temperature ranging between about 900° C. to about 2000° C. The processing temperature may be kept constant or substantially constant for a given period of time, or may be adjusted to one or more other temperatures. The processing temperature for sintering the green body (including the particles) may be at least about 900° C., 950° C., 1000° C., 1050° C., 1100° C., 1150° C., 1200° C., 1300° C., 1400° C., 1500° C., 1600° C., 1700° C., 1800° C., 1900° C., 2000° C., or more. The processing temperature for sintering the green body may be at most about 2000° C., 1900° C., 1800° C., 1700° C., 1600° C., 1500° C., 1400° C., 1300° C., 1200° C., 1150° C., 1100° C., 1050° C., 1000° C., 950° C., 900° C., or less.

In an example, a green body comprising alumina particles may be heated from room temperature to a processing temperature ranging between about 1500° C. to about 1950° C. In an example, a green body comprising cemented carbide particles may be heated from room temperature to a processing temperature ranging between about 1700° C. In an example, a green body comprising zirconia particles may be heated from room temperature to a processing temperature ranging between about 1100° C.

During sintering the green body comprising the ceramic particles, the temperature of the processing chamber may change at a rate ranging between about 0.1° C. per minute (degrees Celsius/min) to about 200° C./min. The temperature of the processing chamber may change at a rate of at least about 0.1° C./min, 0.2° C./min, 0.3° C./min, 0.4° C./min, 0.5° C./min, 1° C./min, 2° C./min, 3° C./min, 4° C./min, 5° C./min, 6° C./min, 7° C./min, 8° C./min, 9° C./min, 10° C./min, 20° C./min, 50° C./min, 100° C./min, 150° C./min, 200° C./min, or more. The temperature of the processing chamber may change at a rate of at most about 200° C./min, 150° C./min, 100° C./min, 50° C./min, 20° C./min, 10° C./min, 9° C./min, 8° C./min, 7° C./min, 6° C./min, 5° C./min, 4° C./min, 3° C./min, 2° C./min, 1° C./min, 0.5° C./min, 0.4° C./min, 0.3° C./min, 0.2° C./min, 0.1° C./min, or less.

In some cases, during sintering the green body comprising the ceramic particles, the process may comprise holding at a fixed temperature between room temperature and the processing temperature for a time ranging between about 1 min to about 240 min. The sintering process may comprise holding at a fixed temperature for at least about 1 min, 10 min, 20 min, 30 min, 40 min, 50 min, 60 min, 90 min, 120 min, 150 min, 180 min, 210 min, 240 min, or more. The sintering process may comprise holding at a fixed temperature for at most about 240 min, 210 min, 180 min, 150 min, 120 min, 90 min, 60 min, 50 min, 40 min, 30 min, 20 min, 10 min, 1 min, or less. In some cases, during the sintering process, the temperature may not be held at a processing temperature for an extended period of time (e.g., once a target temperature is reached, the temperature may be reduced). In an example, the sintering process may increase the temperature to a first temperature and immediately (e.g., without holding at the first temperature for a period of time) lower the temperature to a second temperature that is lower than the first temperature.

During sintering the green body comprising the plurality of particles (e.g. metal, intermetallic, and/or ceramic), the green body may be subjected to cooling by a fluid (e.g., liquid or gas). The fluid may be applied to the green body and/or the processing chamber to decrease the temperature of the green body. The fluid may be subjected to flow upon application of positive or negative pressure. Examples of the fluid for cooling the green body include water, oil, hydrogen, nitrogen, argon, etc. Cooling the green body during the sintering process may control grain size within the sintered body.

In some cases, the mixture (e.g., the viscous liquid) may further comprise an extractable material. Accordingly, the method may comprise additional steps of treating the green body prior to subjecting the green body to sintering.

The extractable material may be removed by heat that is lower or substantially the same as a temperature sufficient for sintering. Alternatively, the extractable material may be soluble in the polymeric precursor and/or dispersed throughout the mixture. Accordingly, the method may comprise curing the polymeric precursor of the mixture in at least a portion of the mixture, thereby creating a first solid phase comprising the polymeric material and a second solid phase comprising the extractable material within the at least the portion of the 3D object. Such method may be a polymerization-induced phase separation (PIPS) process. The plurality of particles (e.g., metallic, intermetallic, and/or ceramic particles) may be encapsulated by the first solid phase comprising the polymeric material. In some cases, the at least the portion of the 3D object may be a green body that can undergo heating to sinter at least a portion of the plurality of particles and burn off at least a portion of other components (i.e., organic components).

In some cases, the extractable material may be soluble in a solvent (e.g., isopropanol). The solvent may be an extraction solvent. A first solubility of the extractable material in the solvent may be higher than a second solubility of the polymeric material in the solvent. The solvent may be a poor solvent for the polymeric material. Accordingly, the method may further comprise (i) treating (e.g., immersed, jetted, etc.) the green body with the solvent (liquid or vapor), (ii) solubilizing and extracting at least a portion of the extractable material from the second solid phase of the green body into the solvent, and (iii) generating one or more pores in the green body. The one or more pores in the green body may be a plurality of pores. In some cases, the method may further comprise treating the green body with the solvent and heat at the same time. The one or more pores may create at least one continuous porous network in the green body. Such process may be a solvent de-binding process.

The solvent for the solvent de-binding process may not significantly swell the polymeric material in the green body. In some cases, the viscous liquid may comprise acrylate-based polymeric precursors. Since acrylate-based polymers are of intermediate polarity, both protic polar solvents (e.g., water and many alcohols such as isopropanol) and non-polar solvents (e.g., heptane) may be used. Examples of the solvent for the solvent de-binding process include water, isopropanol, heptane, limolene, toluene, and palm oil. On the other hand, intermediate polarity solvents (e.g., acetone) may be avoided.

In some cases, the solvent de-binding process may involve immersing the green body in a container comprising the liquid solvent. A volume of the solvent may be at least about 2 times the volume of the green body. The volume of the solvent may be at least about 2, 3, 4, 5, 6, 7, 8, 9, 10 times or more than the volume of the green body. The container comprising the liquid solvent and the green body may be heated to a temperature ranging between about 25° C. to about 50° C. The container comprising the liquid solvent and the green body may be heated (e.g., a water bath, oven, or a heating unit from one or more sides of the green body) to a temperature of at least about 25° C., 26° C., 27° C., 28° C., 29° C., 30° C., 35° C., 40° C., 45° C., 50° C., or more. The container comprising the liquid solvent and the green body may be heated to a temperature of at most about 50° C., 45° C., 40° C., 35° C., 30° C., 29° C., 28° C., 27° C., 26° C., 25° C., or less. The solvent de-binding process may last between about 0.1 hours (h) to about 48 h. The solvent de-binding process may last between at least about 0.1 h, 0.2 h, 0.3 h, 0.4 h, 0.5 h, 1 h, 2 h, 3 h, 4 h, 5 h, 6 h, 12 h, 18 h, 24 h, 30 h, 36 h, 42 h, 48 h, or more. The solvent de-binding may last between at most about 48 h, 42 h, 36 h, 30 h, 24 h, 18 h, 12 h, 6 h, 5 h, 4 h, 3 h, 2 h, 1 h, 0.5 h, 0.4 h, 0.3 h, 0.2 h, 0.1 h, or less. After the solvent de-binding process, the solvent may be removed and the green body may be allowed to dry. A weight of the green body may be measured before and after the solvent de-binding to determine the amount of material extracted from the green body.

After the solvent de-binding process, the green body may be heated (e.g., sintered) and/or cooled as abovementioned. During heating (e.g., sintering), at least a portion of the organic components (e.g., the polymeric material, additives, etc.) may decompose and leave the green body in part through the at least one continuous porous network. The presence of the at least one continuous porous network from the solvent de-binding step may improve the speed of the sintering process.

Subsequent to heating the green body, the heated (e.g., sintered) particles as part of a nascent 3D object may be further processed to yield the 3D object. This may include, for example, performing surface treatment, such as polishing, on the nascent 3D object.

### Additional Aspects for 3D Printing

Another aspect of the present disclosure provides systems for printing a 3D object. A system for printing a 3D object may comprise a build surface configured to support a mixture provided in the present disclosure, e.g., a mixture comprising (i) a polymeric precursor, (ii) a photoinitiator configured to initiate formation of a polymeric material from the polymeric precursor, and (iii) a photoinhibitor configured to inhibit formation of the polymeric material from the polymeric precursor. The system may also include one or more optical sources and a controller operatively coupled to the one or more optical sources. The controller may be configured to direct the one or more optical sources to expose the mixture to (i) a first light having a first wavelength sufficient to cause the photoinitiator to initiate formation of the polymeric material from the polymeric precursor at a location disposed away from the build surface, to print at least a portion of the 3D object, and (ii) a second light having a second wavelength sufficient to cause the photoinhibitor to inhibit formation of the polymeric material from the polymeric precursor at a location adjacent to the build surface. During printing of the at least the portion of the 3D object, a ratio of (i) an energy of the second light sufficient to initiate formation of the polymeric material relative to (ii) an energy of the first light sufficient to initiate formation of the polymeric material may be greater than 1. The systems disclosed herein may utilize all components and configurations described in methods for printing a 3D object of the present disclosure.

The ratio of (i) the energy of the second light sufficient to initiate formation of the polymeric material relative to (ii) the energy of the first light sufficient to initiate formation of the polymeric material may be greater than at least about 1, 2, 3, 4, 5, 6, 7, 8, 9, 10, 11, 12, 13, 14, 15, 16, 17, 18, 19, 20, 25, 30, 40, 50, 100, or more. In an example, the ratio is greater than 5. In another example, the ratio is greater than 10. In another example, the ratio is greater than 20. As an alternative, the ratio may be less than or equal to about 100, 50, 40, 30, 25, 20, 19, 18, 17, 16, 15, 14, 13, 12, 11, 10, 9, 8, 7, 6, 5, 4, 3, or 2.

In some cases, the controller may be operatively coupled to a computer system and the system for printing the 3D object. The controller may be configured or programmed to receive or generate a computer model of the 3D object. The at least the portion of the 3D object may be in accordance to the computer model of the 3D object.

In some cases, the controller may be operatively coupled to the build head. The controller may be configured or programmed to direct movement of the build head along a direction away from the build surface during printing the at least the portion of the 3D object. Alternatively or in addition to, the controller may be operatively coupled to the vat or the open platform. The controller may be configured or programmed to direct movement of the vat or the open platform relative to the build head during printing the at least the portion of the 3D object. In some cases, the controller may direct movement of both (i) the build head and (ii) the vat or the open plat form, thereby to direct their relative movement during printing the 3D object.

The controller may be operatively coupled to other components and their configurations described in the aforementioned method for printing a 3D object.

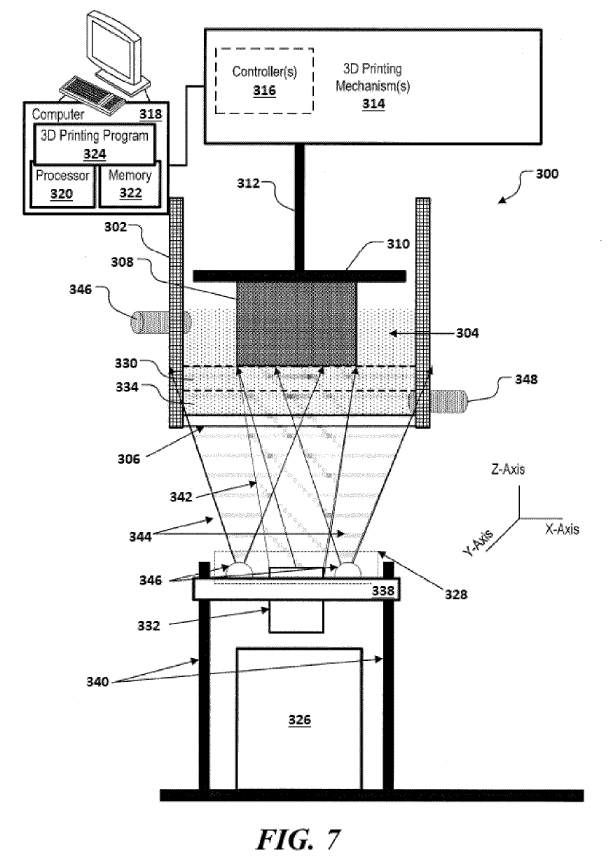

FIG. 7 shows an example of a 3D printing system 300. The system 300 includes a vat 302 to hold a mixture 304, which includes a polymeric precursor. The vat 302 includes a window 306 in its bottom through which illumination is transmitted to cure a 3D printed structure 308. The 3D printed structure 308 is shown in FIG. 7 as a block, however, in practice a wide variety of complicated shapes can be 3D printed. In some cases, the 3D printed structure 308 includes entirely solid structures, hollow core prints, lattice core prints and generative design geometries. Additionally, a 3D printed structure 308 can be partially cured such that the 3D printed structure 308 has a gel-like or viscous mixture characteristic.

The 3D printed structure 308 is 3D printed on a build head 310, which is connected by a rod 312 to one or more 3D printing mechanisms 314. The 3D printing mechanisms 314 can include various mechanical structures for moving the build head 310 within and above the vat 302. This movement is a relative movement, and thus moving pieces can be the build head 310, the vat 302, or both, in various cases. In some cases, the 3D printing mechanisms 314 include Cartesian (xyz) type 3D printer motion systems or delta type 3D printer motion systems. In some cases, the 3D printing mechanisms 314 include one or more controllers 316 which can be implemented using integrated circuit technology, such as an integrated circuit board with embedded processors and firmware. Such controllers 316 can be in communication with a computer or computer systems 318. In some cases, the 3D printing system 100 includes a computer 318 that connects to the 3D printing mechanisms 314 and operates as a controller for the 3D printing system 100.

A computer 318 can include one or more hardware (or computer) processors 320 and a memory 322. For example, a 3D printing program 324 can be stored in the memory 322 and run on the one or more processors 320 to implement the techniques described herein. The controller 318, including the one or more hardware processors 320, may be individually or collectively programmed to implement methods of the present disclosure.

Multiple devices emitting various wavelengths and/or intensities of light, including a light projection device 326 and light sources 328, can be positioned below the window 306 and in communication to the computer 318 (or other controller). In some cases, the multiple devices include the light projection device 326 and the light sources 328. The light sources 328 can include greater than or equal to about 2, 3, 4, 5, 6, 7, 8, 9, 10, or more light sources. As an alternative, the light sources 328 may include less than or equal to about 10, 9, 8 7, 6, 5, 4, 3, 2 or less light sources. As an alternative to the light sources 328, a single light source may be used. The light projection device 326 directs a first light having a first wavelength into the mixture 304 within the vat 302 through window 306. The first wavelength emitted by the light projection device 326 is selected to produce photoinitiation and is used to create the 3D printed structure 308 on the build head 310 by curing the photoactive mixture in the mixture 304 within a photoinitiation layer 330. In some cases, the light projection device 326 is utilized in combination with one or more projection optics 332 (e.g. a projection lens for a digital light processing (DLP) device), such that the light output from the light projection device 326 passes through one or more projection optics 332 prior to illuminating the mixture 304 within the vat 302.

In some cases, the light projection device 326 is a DLP device including a digital micromirror device (DMD) for producing patterned light that can selectively illuminate and cure 3D printed structures 308. The light projection device 326, in communication with the computer 318, can receive instructions from the 3D printing program 324 defining a pattern of illumination to be projected from the light projection device 326 into the photoinitiation layer 330 to cure a layer of the photoactive mixture onto the 3D printed structure 308.

In some cases, the light projection device 326 and projection optics 332 are a laser and a scanning mirror system, respectively (e.g., stereolithography apparatus). Additionally, in some cases, the light source includes a second laser and a second scanning mirror system. Such light source may emit a beam of a second light having a second wavelength. The second wavelength may be different from the first wavelength. This may permit photoinhibition to be separately controlled from photoinitiation. Additionally, in some cases, the platform 338 is separately supported on adjustable axis rails 340 from the projection optics 332 such that the platform 338 and the projection optics 332 can be moved independently.

The relative position (e.g., vertical position) of the platform 338 and the vat 302 may be adjusted. In some examples, the platform 338 is moved and the vat 302 is kept stationary. As an alternative, the platform 338 is kept stationary and the vat 302 is moved. As another alternative, both the platform 338 and the vat 302 are moved.

The light sources 328 direct a second light having a second wavelength into the mixture 304 in the vat 302. The second light may be provided as multiple beams from the light sources 328 into the build area simultaneously. As an alternative, the second light may be generated from the light sources 328 and provided as a single beam (e.g., uniform beam) into the beam area. The second wavelength emitted by the light sources 328 is selected to produce photoinhibition in the photoactive mixture in the mixture 304 and is used to create a photoinhibition layer 334 within the mixture 304 directly adjacent to the window 306. The light sources 328 can produce a flood light to create the photoinhibition layer 334, the flood light being a non-patterned, high-intensity light. In some cases, the light sources 328 are light emitting diodes (LEDs) 336. The light sources 328 can be arranged on a platform 338. The platform 338 is mounted on adjustable axis rails 340. The adjustable axis rails 340 allow for movement of the platform 338 along an axis. In some cases, the platform 338 additionally acts as a heat-sink for at least the light sources 328 arranged on the platform 338.

For each of the light projection device 326 and the light sources 328, there is a beam path for light emitted from the respective light source under normal operating conditions (e.g., device is “on”). For example, a depiction of a beam path for light projection device 326 is shown in FIG. 7 as a projection beam path 342. Beam paths 344 are a depiction of exemplary beam paths for two LEDs 336. Although beam paths 342 and 344 are depicted in FIG. 7 as two-dimensional, a beam path can be three-dimensional with a cross-section that can be circular, elliptical, rectangular, or the like. In some cases, the photoinitiation wavelength is approximately 460 nm, and the photoinhibition wavelength is approximately 365 nm.

The respective thicknesses of the photoinitiation layer 330 and the photoinhibition layer 334 can be adjusted by computer 318 (or other controller). In some cases, this change in layer thickness(es) is performed for each new 3D printed layer, depending on the desired thickness of the 3D printed layer, and/or the type of 3D printing process being performed. The thickness(es) of the photoinitiation layer 330 and the photoinhibition layer 334 can be changed, for example, by changing the intensity of the respective light emitting devices, exposure times for the respective light emitting devices, the photoactive species in the mixture 304, or a combination thereof. In some cases, by controlling relative rates of reactions between the photoactive species (e.g., by changing relative or absolute amounts of photoactive species in the mixture, or by adjusting light intensities of the first and/or second wavelength), the overall rate of polymerization can be controlled. This process can thus be used to prevent polymerization from occurring at the mixture-window interface and control the rate at which polymerization takes place in the direction normal to the mixture-window interface.

For example, in some cases, an intensity of the light sources 328 emitting a photoinhibiting wavelength to create a photoinhibition layer 334 is altered in order to change a thickness of the photoinhibition layer 334. Altering the intensity of the light sources 328 can include increasing the intensity or decreasing the intensity of the light sources 328. Increasing the intensity of the light sources 328 (e.g., LEDs) can be achieved by increasing a power input to the light sources 328 by controllers 316 and/or computer 318. Decreasing the intensity of the light sources 328 (e.g., LEDs) can be achieved by decreasing a power input to the light sources 328 by controllers 316 and/or computer 318. In some cases, increasing the intensity of the light sources 328, and thereby increasing the thickness of the photoinhibition layer 334, will result in a decrease in thickness of the photoinitiation layer 330. A decreased photoinitiation layer thickness can result in a thinner 3D printed layer on the 3D printed structure 308.

In some cases, the intensities of all of the light sources 328 are altered equally (e.g., decreased by a same level by reducing power input to all the light sources by an equal amount). The intensities of the light sources 328 can also be altered where each light source of a set of light sources 328 produces a different intensity. For example, for a set of four LEDs generating a photoinhibition layer 334, two of the four LEDs can be decreased in intensity by 10% (by reducing power input to the LEDs) while the other two of the four LEDs can be increased in intensity by 10% (by increasing power input to the LEDs). Setting different intensities for a set of light sources 328 can produce a gradient of thickness in a cured layer of the 3D printed structure or other desirable effects.

In some cases, the computer 318 (in combination with controllers 316) adjusts an amount of a photoinitiator species and/or a photoinhibitor species in the mixture 304. The photoinitiator and photoinhibitor species can be delivered to the vat 302 via an inlet 346 and evacuated from the vat 302 via an outlet 348. In general, one aspect of the photoinhibitor species is to prevent curing (e.g., suppress cross-linking of the polymers) of the photoactive mixture in the mixture 304. In general, one aspect of the photoinitiation species is to promote curing (e.g., enhance cross-linking of the polymers) of the photoactive mixture in the mixture 304. In some cases, the 3D printing system 100 includes multiple containment units to hold input/output flow from the vat 302.

In some cases, the intensities of the light sources 328 are altered based in part on an amount (e.g., volumetric or weight fraction) of the one or more photoinhibitor species in the mixture and/or an amount (e.g., volumetric or weight fraction) of the one or more photoinitiator species in the mixture. Additionally, the intensities of the light sources 328 are altered based in part on a type (e.g., a particular reactive chemistry, brand, composition) of the one or more photoinhibitor species in the mixture and/or a type (e.g., a particular reactive chemistry, brand, composition) of the one or more photoinitiator species in the mixture. For example, an intensity of the light sources 328 for a mixture 304 including a first photoinhibitor species of a high sensitivity (e.g., a high reactivity or conversion ratio to a wavelength of the light sources 328) can be reduced when compared to the intensity of the light sources 328 for a mixture 304 including a second photoinhibitor species of a low sensitivity (e.g., a low reactivity or conversion ratio to a wavelength of the light sources 328).

In some cases, the changes to layer thickness(es) is performed during the creation of the 3D printed structure 308 based on one or more details of the 3D printed structure 308 at one or more points in the 3D printing process. For example, the respective layer thickness(es) can be adjusted to improve resolution of the 3D printed structure 308 in the dimension that is the direction of the movement of the build head 310 relative to the vat 302 (e.g., z-axis) in the layers that require it.

Though the 3D printing system 300 is described in FIG. 1 as a bottom-up system where the light projection device 326 and the light sources 328 are located below the vat 302 and build head 310, other configurations can be utilized. For example, a top-down system, where the light projection device 326 and the light sources 328 are located above the vat 302 and build head 310, can also be employed.

Other features of the printing system 300 of FIG. 1 may be as described in, for example, U.S. Pat. Publication No. 2016/0067921 (“THREE DIMENSIONAL PRINTING ADHESION REDUCTION USING PHOTOINHIBITION”), which is entirely incorporated herein by reference.

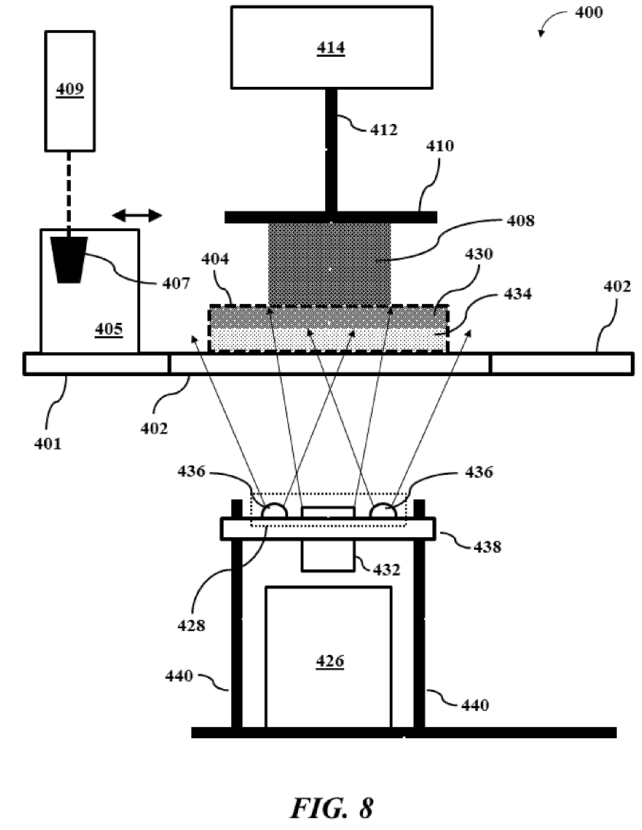

FIG. 8 shows an example of another 3D printing system 400. The system 400 includes an open platform 401 comprising a print window 402 to hold a film of a mixture (e.g., a viscous liquid) 404, which includes a photoactive mixture. The mixture 404 may also include a plurality of particles (e.g., metal, intermetallic, and/or ceramic particles). The system 400 includes a deposition head 405 that comprises a nozzle 407 that is in fluid communication with a source of the mixture 409. The source of the mixture 409 may be a syringe. The syringe may be operatively coupled to a syringe pump. The syringe pump can direct the syringe in a positive direction (from the source of the mixture 409 towards the nozzle 407) to dispense the mixture. The syringe pump can direct the syringe in a negative direction (away from the nozzle 407 towards the source of the mixture 409) to retract any excess mixture in the nozzle and/or on the print window back into the syringe. The deposition head 405 is configured to move across the open platform 401 comprising the print window 402 to deposit the film of the mixture 404. In some cases, the system 400 may comprise an additional source of an additional mixture that is in fluid communication with the nozzle 407 or an additional nozzle of the deposition head 405. In some cases, the system 400 may comprise an additional deposition head comprising an additional nozzle that is in fluid communication with an additional source of an additional mixture. In some cases, the system 400 may comprise three or more deposition heads and three or more sources of the same or different mixtures.

Illumination may be transmitted through the print window 402 to cure at least a portion of the film of the mixture 404 to print at least a portion of a 3D structure 408. The at least the portion of the 3D structure 408 is shown as a block, however, in practice a wide variety of complicated shapes may be printed. In some cases, the at least the portion of the 3D structure 408 includes entirely solid structures, hollow core prints, lattice core prints, and generative design geometries.

The at least the portion of the 3D structure 408 may be printed on a build head 410, which may be connected by a rod 412 to one or more 3D printing mechanisms 414. The 3D printing mechanisms 414 may include various mechanical structures for moving the build head 410 in a direction towards and/or away from the open platform 401. This movement is a relative movement, and thus moving pieces can be the build head 410, the open platform 401, or both, in various embodiments. In some cases, the 3D printing mechanisms 414 include Cartesian (xyz) type 3D printer motion systems or delta type 3D printer motion systems. In some cases, the 3D printing mechanisms 414 include one or more controllers to direct movement of the build head 410, the open platform 401, or both.

Multiple devices emitting various wavelengths and/or intensities of light, including a light projection device 426 and light sources 428, may be positioned below the print window 402 and in communication with the one or more controllers. In some cases, the light sources 428 include greater than or equal to about 2, 3, 4, 5, 6, 7, 8, 9, 10, or more light sources. As an alternative, the light sources 428 can include less than or equal to about 10, 9, 8, 7, 6, 5, 4, 3, 2, or less light sources. As an alternative to the light sources 428, a single light source may be used. The light projection device 426 directs a first light having a first wavelength through the print window 402 and into the film of the mixture 404 adjacent to the print window 402. The first wavelength emitted by the light projection device 426 is selected to produce photoinitiation and is used to create at least a portion of the 3D structure on the at least the portion of the 3D structure 408 that is adjacent to the build head 410 by curing the photoactive mixture in the film of the mixture 404 within a photoinitiation layer 430. In some cases, the light projection device 426 is utilized in combination with one or more projection optics 432 (e.g. a projection lens for a digital light processing (DLP) device), such that the light output from the light projection device 426 passes through the one or more projection optics 432 prior to illuminating the film of the mixture 404 adjacent to the print window 402.

In some cases, the light projection device 426 is a DLP device including a digital micromirror device (DMD) for producing patterned light that can selectively illuminate and cure the photoactive mixture in the photoinitiation layer 430. The light projection device 426, in communication with the one or more controllers, may receive instructions defining a pattern of illumination to be projected from the light projection device 426 into the photoinitiation layer 430 to cure a layer of the photoactive mixture onto the at least the portion of the 3D structure 408.

The light sources 428 direct a second light having a second wavelength into the film of the mixture 404 adjacent to the open platform 401 comprising the print window 402. The second light may be provided as multiple beams from the light sources 428 through the print window 402 simultaneously. As an alternative, the second light may be generated from the light sources 428 and provided as a single beam through the print window 402. The second wavelength emitted by the light sources 428 is selected to produce photoinhibition in the photoactive mixture in the film of the mixture 404 and is used to create a photoinhibition layer 434 within the film of the mixture 404 directly adjacent to the print window 402. The light sources 428 can produce a flood light to create the photoinhibition layer 434, the flood light being a non-patterned, high-intensity light. In some cases, the light sources 428 are light emitting diodes (LEDs) 436. The light sources 428 can be arranged on a light platform 438. The light platform 438 is mounted on adjustable axis rails 440. The adjustable axis rails 440 allow for movement of the light platform 438 along an axis towards or away from the print window 402. The light platform 438 and the one or more projection optics 432 may be moved independently. A relative position of the light platform comprising the light sources may be adjusted to project the second light into the photoinhibition layer 434 at the respective peak intensity and/or in a uniform projection manner. In some cases, the light platform 438 functions as a heat-sink for at least the light sources 428 arranged on the light platform 438.

The respective thicknesses of the photoinitiation layer 430 and the photoinhibition layer 434 may be adjusted by the one or more controllers. In some cases, this change in layer thickness(es) is performed for each new 3D printed layer, depending on the desired thickness of the 3D printed layer, and/or the type of mixture in the film of the mixture 404. The thickness(es) of the photoinitiation layer 430 and the photoinhibition layer 434 may be changed, for example, by changing the intensity of the respective light emitting devices (426 and/or 428), exposure times for the respective light emitting devices, or both. In some cases, by controlling relative rates of reactions between the photoactive species (e.g., at least one photoinitiator and at least one photoinhibitor), the overall rate of curing of the photoactive mixture in the photoinitiation layer 430 and/or the photoinhibition layer 434 may be controlled. This process can thus be used to prevent curing from occurring at the film of the mixture-print window interface and control the rate at which curing of the photoactive mixture takes place in the direction normal to the film of the photoactive mixture-print window interface.

Other features of the printing system 400 of FIG. 2 may be as described in, for example, U.S. Pat. Publication No. 2018/0333912 (“VISCOUS FILM THREE-DIMENSIONAL PRINTING SYSTEMS AND METHODS”), which is entirely incorporated herein by reference.

Any of the methods disclosed herein may further comprise subjecting a printed 3D object (e.g., a green body) to heating (e.g., in a furnace) to, for example, heat a plurality of particles in the mixture. The heating may be under conditions sufficient to sinter the plurality of particles to form a final product that is at least a portion of a 3D object or an entire 3D object. During heating (e.g., sintering), the organic components (e.g., the polymeric material, additives, etc.) may decompose and leave the green body. At least a portion of the decomposed organic components may leave the green body in gas phase.

### Computer Systems

The present disclosure provides computer systems that are programmed to implement methods of the disclosure. Computer systems of the present disclosure may be used to regulate various operations of 3D printing, such as (i) providing a vat containing a mixture comprising a photoactive mixture or a film of the mixture adjacent to an open platform and (ii) directing an optical source to provide light to the mixture to cure at least a portion of the mixture.

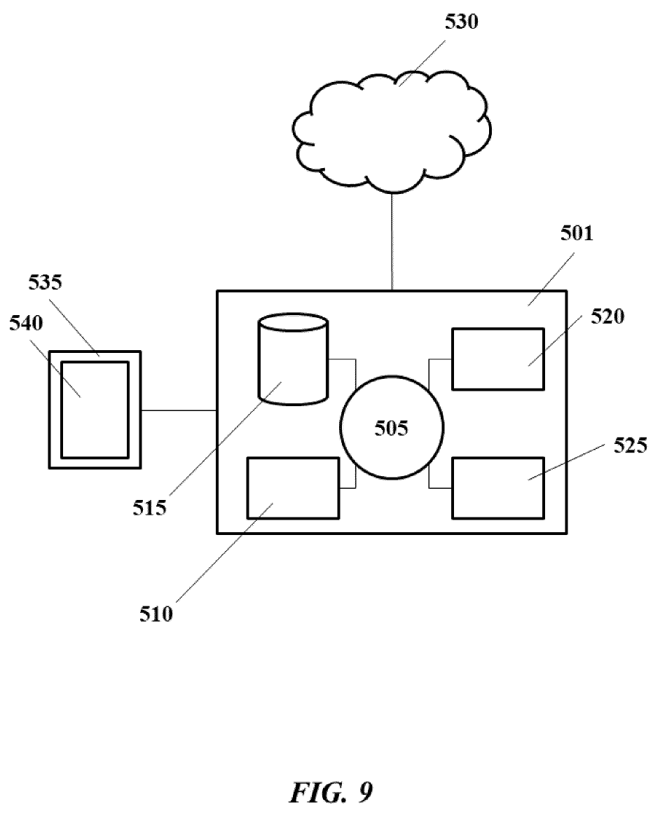

FIG. 9 shows a computer system 501 that is programmed or otherwise configured to communicate with and regulate various aspects of a 3D printer of the present disclosure. The computer system 501 can communicate with the light sources, build head, the inlet and/or outlet of a vat containing the mixture, and/or the open platform configured to hold a film of the mixture. The computer system 501 may also communicate with the 3D printing mechanisms or one or more controllers of the present disclosure. The computer system 501 can be an electronic device of a user or a computer system that is remotely located with respect to the electronic device. The electronic device can be a mobile electronic device.

The computer system 501 includes a central processing unit (CPU, also “processor” and “computer processor” herein) 505, which can be a single core or multi core processor, or a plurality of processors for parallel processing. The computer system 501 also includes memory or memory location 510 (e.g., random-access memory, read-only memory, flash memory), electronic storage unit 515 (e.g., hard disk), communication interface 520 (e.g., network adapter) for communicating with one or more other systems, and peripheral devices 525, such as cache, other memory, data storage and/or electronic display adapters. The memory 510, storage unit 515, interface 520 and peripheral devices 525 are in communication with the CPU 505 through a communication bus (solid lines), such as a motherboard. The storage unit 515 can be a data storage unit (or data repository) for storing data. The computer system 501 can be operatively coupled to a computer network (“network”) 530 with the aid of the communication interface 520. The network 530 can be the Internet, an internet and/or extranet, or an intranet and/or extranet that is in communication with the Internet. The network 530 in some cases is a telecommunication and/or data network. The network 530 can include one or more computer servers, which can enable distributed computing, such as cloud computing. The network 530, in some cases with the aid of the computer system 501, can implement a peer-to-peer network, which may enable devices coupled to the computer system 501 to behave as a client or a server.

The CPU 505 can execute a sequence of machine-readable instructions, which can be embodied in a program or software. The instructions may be stored in a memory location, such as the memory 510. The instructions can be directed to the CPU 505, which can subsequently program or otherwise configure the CPU 505 to implement methods of the present disclosure. Examples of operations performed by the CPU 505 can include fetch, decode, execute, and writeback.

The CPU 505 can be part of a circuit, such as an integrated circuit. One or more other components of the system 501 can be included in the circuit. In some cases, the circuit is an application specific integrated circuit (ASIC).

The storage unit 515 can store files, such as drivers, libraries and saved programs. The storage unit 515 can store user data, e.g., user preferences and user programs. The computer system 501 in some cases can include one or more additional data storage units that are external to the computer system 501, such as located on a remote server that is in communication with the computer system 501 through an intranet or the Internet.

The computer system 501 can communicate with one or more remote computer systems through the network 530. For instance, the computer system 501 can communicate with a remote computer system of a user. Examples of remote computer systems include personal computers (e.g., portable PC), slate or tablet PC’s (e.g., Apple® iPad, Samsung® Galaxy Tab), telephones, Smart phones (e.g., Apple® iPhone, Android-enabled device, Blackberry®), or personal digital assistants. The user can access the computer system 501 via the network 530.

Methods as described herein can be implemented by way of machine (e.g., computer processor) executable code stored on an electronic storage location of the computer system 501, such as, for example, on the memory 510 or electronic storage unit 515. The machine executable or machine readable code can be provided in the form of software. During use, the code can be executed by the processor 505. In some cases, the code can be retrieved from the storage unit 515 and stored on the memory 510 for ready access by the processor 505. In some situations, the electronic storage unit 515 can be precluded, and machine-executable instructions are stored on memory 510.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 501, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 501 can include or be in communication with an electronic display 535 that comprises a user interface (UI) 540 for providing, for example, a window displaying a plurality of mixtures that the user can select to use for 3D printing. Examples of UI’s include, without limitation, a graphical user interface (GUI) and web-based user interface.

Methods and systems of the present disclosure can be implemented by way of one or more algorithms. An algorithm can be implemented by way of software upon execution by the central processing unit 505. The algorithm can, for example, determine appropriate intensity and exposure time of (i) the photoinitiation light and/or (ii) the photoinitiation light during the 3D printing.

Methods and systems of the present disclosure may be combined with or modified by other methods and systems, such as, for example, those described U.S. Pat. Publication No. 2016/0067921 (“THREE DIMENSIONAL PRINTING ADHESION REDUCTION USING PHOTOINHIBITION”), U.S. Pat. Publication No. 2016/0167301 (“POLYMERIC PHOTOINITIATORS FOR 3D PRINTING APPLICATIONS”), U.S. Pat. Publication No. 2018/0348646 (“MULTI WAVELENGTH STEREOLITHOGRAPHY HARDWARE CONFIGURATIONS”), U.S. Pat. Publication No. 2018/0333912 (“VISCOUS FILM THREE-DIMENSIONAL PRINTING SYSTEMS AND METHODS”), U.S. Pat. Publication No. 20180361666 (“METHODS AND SYSTEMS FOR STEREOLITHOGRAPHY THREE-DIMENSIONAL PRINTING”), and International Patent Application No. PCT/US2020/033279 (“STEREOLITHOGRAPHY THREE-DIMENSIONAL PRINTING SYSTEMS AND METHODS”), each of which is entirely incorporated herein by reference.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1-85. (canceled)

86. A feedstock mixture for three-dimensional (3D) printing, comprising:
a polymeric precursor configured to form a polymeric material, wherein said polymeric material is configured to decompose at a first temperature;
a first plurality of particles comprising a first metal; and
a soluble metallic precursor compound configured to react at a second temperature to form a second plurality of particles comprising a second metal capable of alloying with said first metal.

87. The feedstock mixture of claim 86, wherein said second temperature is less than or equal to said first temperature.

88. The feedstock mixture of claim 86, wherein a weight ratio between said first metal (M1) and said second metal (M2) in said feedstock mixture is greater than 5:5 (M1:M2).

89. The feedstock mixture of claim 86 wherein said first plurality of particles comprising said first metal has an average diameter between about 5 micrometer (µm) and about 60 µm.

90. The feedstock mixture of claim 86, wherein said second plurality of particles comprising said second metal has an average diameter between about 10 nanometer (nm) and about 500 nm.

91. The feedstock mixture of claim 86, wherein a melting temperature of said first metal is higher than a melting temperature of said second metal.

92. The feedstock mixture of claim 86, wherein said first plurality of particles comprises stainless steel particles.

93. The feedstock mixture of claim 86, wherein said first metal comprises one or more members selected from the group consisting of chromium, nickel, manganese, and iron.

94. The feedstock mixture of claim 86, wherein said soluble metallic precursor compound comprises an organometallic compound.

95. A method for printing a three-dimensional (3D) object, comprising:
(a) providing a mixture comprising (i) a polymeric precursor configured to form a polymeric material, wherein said polymeric material is configured to decompose at a first temperature, (ii) a first plurality of particles comprising a first metal, and (iii) a soluble metallic precursor compound configured to react at a second temperature to form a second plurality of particles comprising a second metal capable of alloying with said first metal; and
(b) exposing said mixture to a stimulus to cause at least a subset of said plurality of polymeric precursor to form said polymeric material that at least partially encapsulates said first plurality of particles and said soluble metallic precursor compound.

96. The method of claim 95, wherein said second temperature is less than or equal to said first temperature.

97. The method of claim 95, wherein a weight ratio between said first metal (M1) and said second metal (M2) in said mixture is greater than 5:5 (M1:M2).

98. The method of claim 95, wherein said first plurality of particles has an average diameter between about 5 micrometer (µm) and about 60 µm.

99. The method of claim 95, wherein said second plurality of particles has an average diameter between about 10 nanometer (nm) and about 500 nm.

100. The method of claim 95, wherein a melting temperature of said first metal is higher than a melting temperature of said second metal.

101. The method of claim 95, further comprising, subsequent to (b), subjecting said polymeric material that at least partially encapsulates said first plurality of particles and said soluble metallic precursor compound to heat, to (1) decompose at least a portion of said polymeric material and (2) cause said soluble metallic precursor compound to react to form said second plurality of particles, thereby forming a brown body.

102. The method of claim 101, wherein said heat is at a third temperature that is higher than or equal to (i) said first temperature and (ii) said second temperature.

103. The method of claim 102, further comprising subjecting said brown body to heat at a sintering temperature to cause said first metal of said first plurality of particles and said second metal of said second plurality of particles to form an alloy, wherein said sintering temperature is higher than said third temperature, thereby forming at least a portion of a 3D metal object.

104. The method of claim 95, wherein said first plurality of particles comprises stainless steel particles.

105. The method of claim 95, wherein said first metal comprises one or more members selected from the group consisting of chromium, nickel, manganese, and iron.

106. The method of claim 95, wherein said soluble metallic precursor compound comprises an organometallic compound.
